(19) United States
(12) Patent Application Publication
(10) Pub. No.: US 2009/0018711 A1
(43) Pub. Date: Jan. 15, 2009

(54) DETECTING DEVICE, DETECTING METHOD, AND PROGRAM

(75) Inventors: Tadakazu Ueda, Kyoto-shi (JP); Yoshinobu Asokawa, Kasugai-shi (JP); Yoshiro Ito, Kasugai-shi (JP); Takashi Iketani, Kasugai-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto-shio (JP)

(21) Appl. No.: 12/138,113

(22) Filed: Jun. 12, 2008

(30) Foreign Application Priority Data
Jul. 10, 2007 (JP) 2007-180969

(51) Int. Cl. B60W 40/00

(52) U.S. Cl. 701/1

(57) ABSTRACT

Information necessary to control a vehicle is to be effectively detected in accordance with a situation. A supposition situation selecting section selects a supposition situation closest to the present situation of an own vehicle from a plurality of pre-supposed supposition situations on the basis of situation information acquired from a situation information acquiring unit and a supposition situation selection table through a situation information input I/F circuit. A detection process selecting portion selects a detection process to be actually performed from detection processes which can be performed by each detecting portion of a target detecting section on the basis of the selected supposition situation and a detection process selection table. The invention is applicable to an in-vehicle image processing device.

### BACKGROUND OF THE INVENTION

1. Field of the Invention

The present invention relates to a detecting device, a detecting method, and a program, and more particularly relates to the detecting device, the detecting method, and the program capable of effectively detecting information necessary to control a vehicle.

2. Description of Related Art

In the past, there was disclosed a forward monitoring device which detects a forward obstacle such as a forward vehicle, a parked vehicle, and a pedestrian and an interrupting obstacle such as a vehicle which is interrupting in a lane or area of the own vehicle and a pedestrian, in order to detect a location at which the obstacle is located closest to the own vehicle among the detected obstacles as a final obstacle location (for example, see JP-A-2004-280194 (Patent Document 1)).

Recently, there has been the spread of an in-vehicle function which uses information on a predetermined target detected using a photographed surrounding image of a vehicle. As the in-vehicle function, a lane-deviation alarming function of alarming deviation of the vehicle, an automatic tracking function of automatically tracking movement of a forward vehicle, and a collision alleviation brake function of predicting collision of the vehicle and automatically applying a brake are exemplified.

In a vehicle having a forward monitoring device disclosed in Patent Document 1 and a plurality of the above-described in-vehicle functions, for example, it is necessary to detect information on a plurality of targets such as different vehicles, pedestrians, and lanes. However, appropriate detecting methods of precisely detecting necessary information are generally different from each other in accordance with the targets. Accordingly, different detection processing programs for the targets are mounted and a plurality of programs are generally executed to detect information on the plurality of targets.

However, if the targets to be detected increase, programs to be executed also increase. Accordingly, there arises a problem that the detecting process cannot be terminated within a predetermined period of time. In order to solve such a problem, an increase in the number of processing means such as a CPU (Central Processing Unit) or a CPU core can be taken into consideration to process the plurality of programs in parallel. However, in this case, there arise problems that the size of hardware increases, the structure of a circuit becomes complicated, and cost increases.

### SUMMARY OF THE INVENTION

The invention is conceived in view of the above-mentioned circumstance and is designed to effectively detect information required to control a vehicle in accordance with a situation.

According to an aspect of the invention, there is provided a detecting device which performs a plurality of detection processes of detecting information on a predetermined target, the information being used to control a vehicle, and detects information on a plurality of the targets. The detecting device includes: situation selecting means for selecting a supposition situation closest to a situation of the vehicle from a plurality of the supposition situations supposed in advance on the basis of information on a state of the vehicle or a surrounding situation of the vehicle; and detection process selecting means for selecting the detection process to be actually performed from the plurality of detection processes on the basis of the selected supposition situation.

In the detecting device according to the aspect of the invention, the supposition situation closest to the situation of the own vehicle is selected from the plurality of the supposition situations supposed in advance on the basis of the information on the state of the vehicle or the surrounding situation of the vehicle. Moreover, the detection process to be actually performed is selected from the plurality of detection processes on the basis of the selected supposition situation.

Accordingly, the detection process to be performed can be selected in accordance with the situation of the own vehicle. Moreover, it is possible to effectively detect information used to control the vehicle.

The situation selecting means and the detection process selecting means are configured by, for example, a CPU (Central Processing Unit) and a hardware circuit for exclusive use.

The detection process selecting means may determine a sequence for performing the detection processes on the basis of the supposition situation.

Accordingly, it is possible to the information used to control the vehicle in accordance with a sequence of the situations of the vehicle.

The supposition situation may be a situation which is supposed on the basis of a situation in which a driver has to be careful during driving.

Accordingly, it is possible to effectively detect the information used to control the vehicle in the situation in which a driver has to be careful.

The detection process selecting means may select the detection process of detecting information on the target which a driver has to be careful of in the selected supposition situation.

Accordingly, it is possible to rapidly and effectively detect the information on the target which a driver has to be careful of.

The detection process selecting means may determine a sequence for performing the detection processes on the basis of a sequence of the targets which a driver has to be careful of.

Accordingly, it is possible to detect the information on the target which a driver has to be careful of in accordance with the sequence in which a driver has to be careful.

According to another aspect of the invention, there is provided a method of controlling a detection process of a detecting device which performs a plurality of the detection processes of detecting information on a predetermined target, the information being used to control a vehicle, and detects information on a plurality of the targets, or there is provided a program for allowing a detection process controlling process to be executed on a computer of a detecting device which performs a plurality of detection processes of detecting information on a predetermined target, the information being used to control a vehicle, and detects information on a plurality of the targets. The method or the program includes: a situation selecting step of selecting a supposition situation closest to a situation of the vehicle from a plurality of the supposition situations supposed in advance on the basis of information on a state of the vehicle or a surrounding situation of the vehicle; and a detection process selecting step of selecting the detection process to be performed from the plurality of detection processes on the basis of the selected supposition situation.

In the detecting method or the program according to another aspect of the invention, the supposition situation closest to the situation of the own vehicle is selected from the plurality of supposition situations supposed in advance, and the detection process to be actually performed is selected from the plurality of detection processes on the basis of the selected supposition situation.

Accordingly, the detection process to be performed can be selected in accordance with the situation of the own vehicle. Moreover, it is possible to effectively the information used to control the vehicle.

The situation selection step is configured, for example, by the situation selecting step of selecting the supposition situation closest to the situation of the own vehicle from the plurality of supposition situations supposed in advance by use of the CPU on the basis of the information on the state of the vehicle or the surrounding situation of the vehicle. In addition, the detection process selecting step is configured, for example, by the detection process selecting step of selecting the detection process to be performed from the plurality of supposition processes by the use of the CUP on the basis of the selected supposition situation.

According to some aspect of the invention, a detecting process to be performed can be selected in accordance with a situation under which a vehicle is. Moreover, according to some aspect of the invention, information required to control the vehicle can be effective detected.

### BRIEF DESCRIPTION OF THE DRAWINGS

FIG. 1 is a block diagram illustrating a detecting system according to an embodiment of the invention.

FIG. 2 is a flowchart for explaining a detection process performed by the detecting system according to the invention.

FIG. 3 is a diagram illustrating an example of a supposition situation selection table A.

FIG. 4 is a diagram illustrating an example of a process selection table.

FIG. 5 is a diagram illustrating an example of a supposition situation selection table B.

FIG. 6 is a diagram illustrating an example of a supposition situation selection table C.

FIG. 7 is a diagram illustrating an example of an area as a target of a detection process D1.

FIG. 8 is a diagram illustrating an example of the area as the target of the detection process D1.

FIG. 9 is a diagram illustrating an example of a supposition situation selection table D.

FIG. 10 is a diagram illustrating an example of a supposition situation selection table E.

FIG. 11 is a diagram illustrating an example of an area as a target of a detection process D2.

FIG. 12 is a diagram illustrating an example of the area as the target of the detection process D2.

FIG. 13 is a diagram illustrating an example of an area as a target of a detection process B6.

FIG. 14 is a diagram illustrating an example of the area as the target of the detection process B6.

FIG. 15 is a diagram illustrating an example of a supposition situation selection table F.

FIG. 16 is a table showing time necessary for a detection process in each supposition situation.

FIG. 17 is a block diagram illustrating an example of a specific circuit configuration for realizing a detecting unit.

FIG. 18 is a block diagram illustrating the example of the specific circuit configuration for realizing the detecting unit

FIG. 19 is a block diagram illustrating an example of the configuration of a personal computer.

### DESCRIPTION OF PREFERRED EMBODIMENTS

Hereinafter, an embodiment of the invention will be described with reference to the drawings.

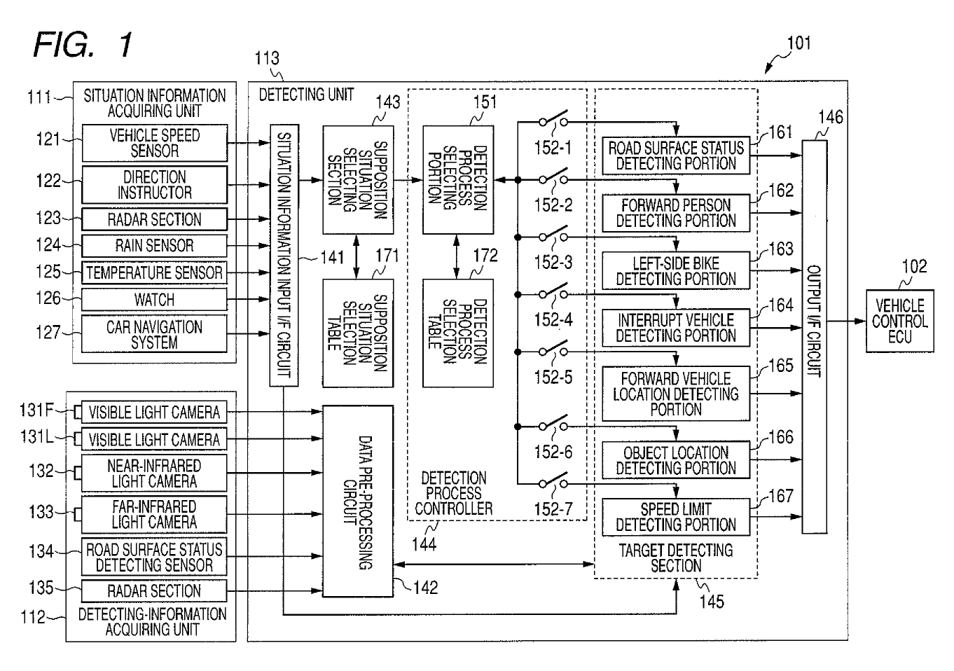

FIG. 1 is a block diagram illustrating a detecting system according to an embodiment of the invention. A detecting system 101 according to the invention is a system which is provided in a vehicle to detect information on a predetermined target. The information is used to control the vehicle (hereinafter, referred to as an own vehicle).

The detecting system 101 is configured so as to include a situation-information acquiring unit 111, a detecting-information acquiring unit 112, and a detecting device 113. The situation information acquiring unit 111 includes a vehicle speed sensor 121, a direction instructor 122, a radar section 123, a rain sensor 124, a temperature sensor 125, a clock 126, and a car navigation system 127. The detecting-information acquiring unit 112 includes a visible light camera 131F, a visible light camera 131L, a near-infrared light camera 132, afar-infrared light camera 133, a road surface status monitoring sensor 134, and a radar section 135. The detection device 113 includes a situation information input interface (I/F) circuit 141, a data pre-processing circuit 142, a supposition situation selecting section 143, a detection process controller 144, a target detecting section 145, and an output interface (I/F) circuit 146. The detection process controller 144 includes a detection process selecting portion 151 and switches 152-1 to 152-7. The target detecting section 145 includes a road surface status detecting portion 161, a forward person detecting portion 162, a left-side bike detecting portion 163, an interrupt vehicle detecting portion 164, a forward vehicle location detecting portion 165, an object location detecting portion 166, and a speed limit detecting portion 167.

The situation information acquiring unit 111 acquires information (hereinafter, referred to as situation information) on an own vehicle situation and a surrounding situation of the own vehicle and supplies the situation information input T/F circuit 141 with data indicating the acquired situation information.

Of the constituent elements included in the situation information acquiring unit 111, the vehicle speed sensor 121 is, for example, a vehicle speed sensor provided in the own vehicle. The vehicle speed sensor 121 detects a vehicle speed of the own vehicle to supply the situation information input I/F circuit 141 with data indicating the detected vehicle speed.

The direction instructor 122 is a direction instructor provided in the own vehicle. The direction instructor 122 supplies data indicating a status of a switch which switches blinking of a lamp of the direction instructor 122. That is, the direction instructor 122 supplies the situation information input I/F circuit 141 with the data indicating one of three statuses of no blinking, blinking of a right lamp, blinking of a left lamp.

The radar section 123 uses beams such as electric waves like millimeter waves and microwaves or laser beams to detect whether a vehicle, a bicycle, a person, an animal, an obstacle, and the like are present or not in the front of the own vehicle. The radar section 123 detects the size and position of an object, detects whether the object is a vehicle or not, and detects the relative speed of the object with respect to the own vehicle when the object is present in the front of the own vehicle. In addition, the radar section 123 detects the location of a lane in which the own vehicle is traveling (hereinafter, referred to as an own vehicle lane) by detecting a line and the like marked on a road surface. In addition, the radar section 123 supplies the situation information input I/F circuit 141 with data indicating the detection results.

The rain sensor 124 detects an amount of rain or snow adhered on, for example, a wind shield glass (so-called front glass) of the own vehicle by use of an optical sensor. The rain sensor 124 supplies the situation information input I/F circuit 141 with data indicating the amount of detected rain or snow.

The temperature sensor 125, which is installed at a position at which an outside temperature of the own vehicle (hereinafter, referred to as a surrounding temperature) or a temperature of the road surface on which the own vehicle is traveling (hereinafter, referred to as a road surface temperature) can be detected, supplies the situation information input I/F circuit 141 with data indicating the detected surrounding temperature or the detected road surface temperature.

The clock 126 supplies the situation information input I/F circuit 141 with data indicating present clock.

The car navigation system 127 receives electric waves from a near-positioned satellite through a GPS (Global Positioning System) to measure a present position of the own vehicle. The car navigation system 127 detects location of the own vehicle on a map on the basis of map information of a digital map or the like, and collects information on, for example, whether the present location of the own vehicle is an urban district or a suburban district and whether the present road is a road for an automobile or not. The car navigation system 127 supplies the situation information input I/F circuit 141 with data indicating the information on the present location thereof.

The detecting-information acquiring unit 112 acquires information (hereinafter, referred to as detecting information) used to detect information on a predetermined target used to control the own vehicle, and supplies the acquired detecting information to the data pre-processing circuit 142.

Of the constituent elements included in the detecting-information acquiring unit 112, the visible light camera 131F and the visible light camera 131L are each a camera which has a sufficient sensitivity at least for light of a visible light range. The visible light camera 131F is installed at a position at which the forward side of the own vehicle can be photographed, and an image (hereinafter, referred to as a forward side image) photographed at the forward side of the own vehicle is supplied to the data pre-processing circuit 142. The visible light camera 131L is installed at a position at which a bike or the like passing the left side of the own vehicle is photographed, and an image (hereinafter, referred to as a left side image) photographed at the left side of the own vehicle is supplied to the data pre-processing circuit 142.

The near-infrared light camera 132 is a camera which has a sufficient sensitivity at least for light in a range from the visible light area to the near-infrared light area. Like the visible light camera 131F, the near-infrared light camera 132 is installed at the position at which the forward side of the own vehicle can be photographed, and photographs the forward side of the vehicle while radiating the near-infrared light to the forward side of the vehicle. Accordingly, the near-infrared light camera 132 can clearly photograph the forward side of the vehicle even in a situation in which surroundings are dark at night, etc. The near-infrared light camera 132 supplies the photographed forward side image to the data pre-processing circuit 142.

The far-infrared light camera 133 is a camera which has a sufficient sensitivity at least for light in a range from the visible light area to the far-infrared light area. Like the visible light camera 131F, the far-infrared light camera 133 is installed at the position at which the forward side of the own vehicle can be photographed, and photographs the forward side of the vehicle while radiating the far-infrared light to the forward side of the vehicle. Accordingly, the far-infrared light camera 133 can clearly photograph the forward side of the vehicle even in a situation in which a glare phenomenon particularly occurs at raining night. The far-infrared light camera 133 supplies the photographed forward side image to the data pre-processing circuit 142.

The road surface status monitoring sensor 134 radiates light such as infrared light onto a road surface and detects the brightness or shape of the road surface on the basis of the reflecting light to identify a road surface status such as dryness, dampness, or freezing on the basis of the detection result. The road surface status monitoring sensor 134 supplies the data pre-processing circuit 142 with data indicating the identified road surface status.

The radar section 135 uses light such as electric waves like millimeter waves and microwaves or laser beams to detect whether a bike passing the left side of the own vehicle is present or not, detects the size and position of the bike, or detects the relative speed of the bike with respect to the own vehicle. The radar section 135 supplies the data pre-processing circuit 142 with data indicating the detection result.

The detecting device 113 is a device which detects information on a predetermined target used to control the own vehicle. The detecting device 113 can detect information on a plurality of the target by performing a plurality of detecting processes.

Of the constituent elements included in the detecting device 113, the situation information input I/F circuit 141 converts data supplied from the vehicle speed sensor 121, the direction instructor 122, the radar section 123, the rain sensor 124, the temperature sensor 125, the clock 126, and the car navigation system 127 into a format which the supposition situation selecting section 143 or the detecting portions of the target detecting section 145 can process, and supplies the converted data to the supposition situation selecting section 143 or the detecting portions of the target detecting section 145.

The data pre-processing circuit 142 supplies the image or the data supplied from the visible light camera 131F, the visible light camera 131L, the near-infrared light camera 132, the far-infrared light camera 133, the road surface status monitoring sensor 134, and the radar section 135 to the detecting portions of the target detecting section 145, if necessary. At this time, the data pre-processing circuit 142 converts the acquired image or data into an image or data suitable for a process of the detecting portions on the basis of a command from the detecting portions of the target detecting section 145.

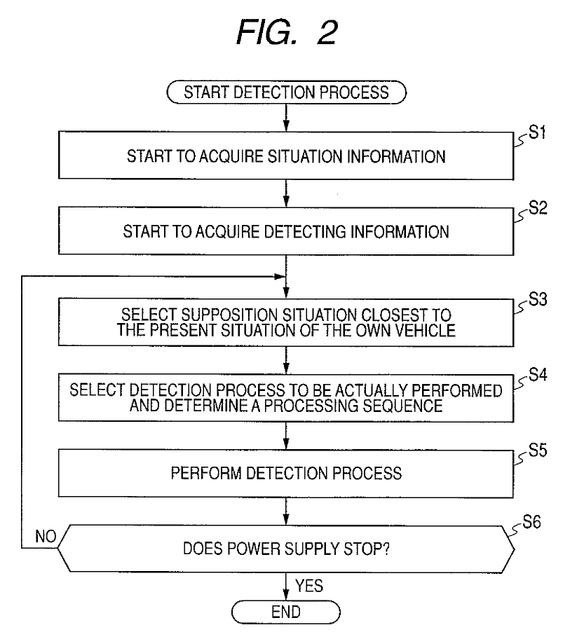

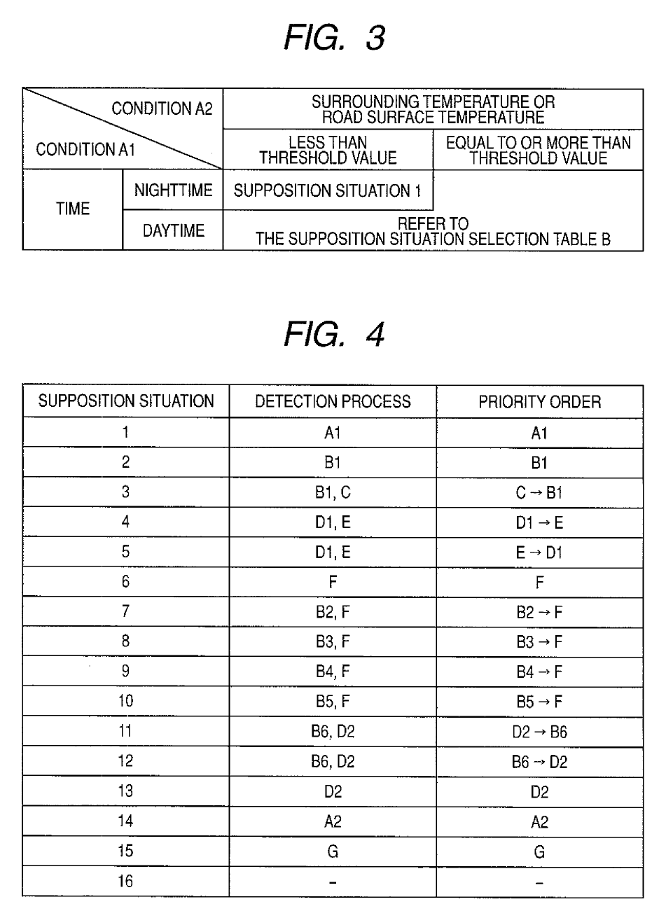

As described below with reference to FIG. 2 and the like, on the basis of situation information and a supposition situation selection table 171, the supposition situation selecting section 143 selects a supposition closest to the present situation of the own vehicle and the surroundings of the own vehicle, that is, a supposition closest to a situation of the own vehicle from situations (hereinafter, a supposition situation) which are supposed on the basis of situations in which a driver has to be careful during driving. The supposition situation selecting section 143 supplies the detection process selecting portion 151 with information indicating the selected supposition situation. The supposition situation selection table 171 is a table for selecting the supposition situation prepared on the basis of the situation information and will be described in detail with reference to FIG. 3 and the like.

The detection process controller 144 selects processing necessity and a processing sequence of a detection process which can be performed by the detecting portions included in the target detecting section 145, and controls the detecting portions so as to perform the detection process in accordance with the selection result.

Of the constituent elements included in the detection processing controller 144, the detection process selecting portion 151 selects a detection process to be actually performed from a plurality of the detection processes which can be performed by the detecting portions included in the target detecting section 145 on the basis of the supposition situation selected by the supposition situation selecting section 143 and a detection process selection table 172, as described below with reference to FIG. 2 and the like. The detection process selecting portion 151 selects a sequence for sequentially performing the selected detection processes on the basis of the detection process selection table 172. The detection process selecting portion 151 switches the switches 152-1 to 152-7 on or off and instructs the detecting portions included in the target detecting section 145 to perform the detection processes to control the detecting portions so as to perform the selected detection processes in accordance with the determined sequence. The detection process selection table 172 is a table for selecting the detection process to be actually performed and determining a sequence of the selected detection processes, and will be described in detail below with reference to FIG. 4 and the like.

The target detecting section 145 performs the detection process selected by the detection processing controller 144 in accordance with the determined sequence to supply an output I/F circuit 146 with information indicating the detection result.

Of the respective constituent elements included in the target detecting section 145, the road surface status detecting portion 161 acquires the forward side image photographed by the visible light camera 131F and data indicating the road surface status monitoring sensor 134 from the data pre-processing circuit 142. On the basis of the forward side image or the data indicating the road surface status, the road surface status detecting portion 161 uses a predetermined technique to detect a frozen status of a road surface such as whether the road surface on which the own vehicle is traveling is frozen, where the road surface is frozen, and how much the road surface is frozen. The road surface status detecting portion 161 supplies the output I/F circuit 146 within formation indicating the detection result. The technique for detecting the frozen status of the road surface and being used by the road surface status detecting portion 161 is not limited to a specific technique. However, a technique for detecting the frozen status of the road surface more rapidly and exactly may be preferable.

The forward person detecting portion 162 acquires data indicating a vehicle speed of the own vehicle detected by the vehicle sensor 121 and data indicating the location of the own vehicle lane detected by the radar section 123 from the situation information input I/F circuit 141. In addition, the forward person detecting portion 162 acquires the forward side image photographed by the visible light camera 131F, the near-infrared light camera 132, or the far-infrared light camera 133 from the data pre-processing circuit 142. On the basis of the forward side image, the forward person detecting portion 162 detects whether a person including a person riding a bicycle or bike is present in the front of the own vehicle, where the person is located, which direction the person moves using a predetermined technique. The forward person detecting portion 162 supplies the output I/F circuit 146 with information indicating the detection result. The technique used by the forward person detecting portion 162 to detect whether the person is present in the front of the own vehicle, where the person is located, which direction the person moves is not limited to a specific technique. However, a technique for detecting whether the person is present in the front of the own vehicle, where the person is located, which direction the person moves more rapidly and exactly may be preferable.

The left-side bike detecting portion 163 acquires a left-side image photographed by the visible light camera 131L and data indicating the detection result of the radar section 135 from the data pre-processing circuit 142. On the basis of the left-side image or the detection result of the radar section 135, the left-side bike detecting portion 163 detects whether a bike traveling at the left side of the own vehicle is present, where the bike is located, and which direction the bike is traveling, using a predetermined technique. The left-side bike detecting portion 163 supplies the output I/F circuit 146 with information indicating the detection result. The technique used by the left-side hike detecting portion 163 which detects whether a bike traveling at the left side of the own vehicle is present, where the bike is located, and which direction the bike is traveling is not limited to a specific technique. However, a technique for detecting whether a bike traveling at the left side of the own vehicle is present, where the bike is located, and which direction the bike is traveling more rapidly and exactly may be preferable.

The interrupt vehicle detecting portion 164 acquires data indicating the vehicle speed of the own vehicle detected by the vehicle speed sensor 121 and data indicating the location of the own vehicle lane detected by the radar section 123 from the situation information input I/F circuit 141. In addition, the interrupt vehicle detecting portion 164 acquires the forward side image photographed by the visible light camera 131F from the data pre-processing circuit 142. On the basis of the forward side image, the interrupt vehicle detecting portion 164 detects whether an interrupt vehicle interrupting in the front of the own vehicle from another vehicle lane is present, where the interrupt vehicle is located, and which direction the interrupt vehicle is traveling, using a predetermined technique. The interrupt vehicle detecting portion 164 supplies the output I/F circuit 146 within formation indicating the detection result. The technique used by the interrupt vehicle detecting portion 164 which detects whether the interrupt vehicle is present, where the interrupt vehicle is located, and which direction the interrupt vehicle is traveling is not limited to a specific technique. However, a technique for detecting whether the interrupt vehicle is present, where the interrupt vehicle is located, and which direction the interrupt vehicle is traveling more rapidly and exactly may be preferable.

The forward vehicle location detecting portion 165 acquires data indicating the location of the own vehicle lane detected by the radar section 123 from the situation information input I/F circuit 141. In addition, the forward vehicle location detecting portion 165 acquires the forward side image photographed by the visible light camera 131F from the data pre-processing circuit 142. On the basis of the forward side image, the forward vehicle location detecting portion 165 detects the location and the vehicle width of the forward vehicle located in the front of the own vehicle and calculates how much the own vehicle moves to avoid collision with the forward vehicle toward the left side or the right side, using a predetermined technique. The forward vehicle location detecting portion 165 supplies information indicating the detection result and the avoid degree to the out I/F circuit 146. The technique used by the forward vehicle location detecting portion 165 which detects the location and the vehicle width of the forward vehicle is not limited to a specific technique. However, a technique for detecting the location and the vehicle width of the forward vehicle more rapidly and exactly may be preferable.

The object location detecting portion 166 acquires data indicating the location of the own vehicle detected by the radar section 123 from the situation information input I/F circuit 141. In addition, the object location detecting portion 166 acquires the forward side image photographed by the visible light camera 131F from the data pre-processing circuit 142. On the basis of the forward side image, the object location detecting portion 166 detects the location and size of an object located within the own vehicle lane in the front of the own vehicle and calculates how much the own vehicle moves to avoid collision with the object, using a predetermined technique. The object location detecting portion 166 supplies the output I/F circuit 146 within formation indicating the detection result. The technique used by the object location detecting portion 166 which detects the location and size of the forward object is not limited to a specific technique. However, a technique for detecting the location and size of the forward object more rapidly and exactly may be preferable.

The speed limit detecting portion 167 acquires data indicating the location of the own vehicle lane detected by the radar section 123 from the situation information input I/F circuit 141. In addition, the speed limit detecting portion 167 acquires the forward side image photographed by the visible light camera 131F from the data pre-processing circuit 142. On the basis of the forward side image, the speed limit detecting portion 167 detects a speed limit presented on a road surface or a road sign in the front of the own vehicle lane, using a predetermined technique. The speed limit detecting portion 167 supplies the output I/F circuit 146 with information indicating the detection result. The technique used by the speed limit detecting portion 167 which detects the speed limit is not limited to a specific technique. However, a technique for detecting the speed limit more rapidly and exactly may be preferable.

The output I/F circuit 146 controls the output of the detection result for a vehicle control ECU (Electronic Control Unit) 102 by performing a converting process of an output format of information indicating the detection result obtained from the detecting portions of the target detecting section 145, an adjusting process of output timing, or the like.

The vehicle control ECU 102 controls operations of various electronic control devices mounted in the own vehicle on the basis of the detection result output from the detecting device 113.

Next, the detection process performed by the detecting system 101 will be described with reference to FIG. 2. For example, such a process starts when an engine of a vehicle provided with the detecting system 101 is started and a power supply to the detecting system 101 is started.

In Step S1, the situation information acquiring unit 111 starts acquiring of situation information. Specifically, the vehicle sensor 121 starts to detect the vehicle speed of the own vehicle and to supply the situation information input I/F circuit 141 with data indicating the detected vehicle speed. The direction instructor 122 starts to supply the situation information input I/F circuit 14 with data indicating the status of the switches for switching blinking of the lamp. The radar section 123 starts to detect whether an object located in the front of the own vehicle is present, where the object is located, what size the object is, how rapidly the object moves with respect to the own vehicle, whether the object is a vehicle, and the like. In addition, the radar section starts to supply the situation information input I/E circuit 141 with data indicating the detection result. The rain sensor 124 starts to detect rain drops and to supply the situation information input I/F circuit 141 with information indicating an amount of detected rain. The temperature sensor 125 starts to detect a surrounding temperature or a road surface temperature and to supply the situation information input I/F circuit 141 with data indicating the detected surrounding temperature or the detected road surface temperature. The clock 126 starts to supply the situation information input I/F circuit 141 with data indicating the present time. The car navigation system 127 starts to collect information on a traveling location to supply the collected information to the situation information input I/F circuit 141.

In Step S2, the detecting-information acquiring unit 112 starts to acquire detecting information. Specifically, the visible light camera 131F, the near-infrared light camera 132, and the far-infrared light camera 133 starts to photograph the front of the own vehicle to supply the photographed forward side image to the data pre-processing circuit 142. The visible light camera 131L starts to photograph the left side of the own vehicle to supply the photographed left side image to the data pre-processing circuit 142. The road surface status monitoring sensor 134 starts to monitor the road surface status during traveling to supply the data pre-processing circuit 142 with information indicating the monitoring result. The radar section 135 starts to detect whether a bike traveling at the left side of the own vehicle is present, what size the bike is, where the bike is, and how much rapidly the bike is traveling to supply the data pre-processing circuit 142 with information indicating the detection result.

In Step S3, the supposition situation selecting section 143 selects the supposition status closest to the present situation of the own vehicle on the basis of supposition information and the supposition situation selection table 171. The supposition situation selecting section 143 supplies the detection process selecting portion 151 with information indicating the selected supposition situation.

In Step S4, the detection process selecting portion 151 selects the detection process to be actually performed and determines a processing sequence on the basis of the detection process selection table 172.

In Step S5, the target detecting section 145 performs the detection process on the basis of the command supplied from the detection process selecting portion 151. Of the detecting portions of the target detecting section 145, the detecting portion which has actually performed the detection process supplies the vehicle control ECU 102 with information indicating the detection result through the output I/F circuit 146. The vehicle control ECU 102 controls an operation of each element of the vehicle on the basis of the acquired detection result.

Here, a specific example of the processes of Steps S3 to S5 will be described with reference to FIGS. 3 to 15. Hereinafter, an example in which the supposition situation selection table 171 is composed of six tables of supposition situation selection tables A to F will be described.

The supposition situation selecting section 143 first selects the supposition situation selection A, which is shown in FIG. 3, from the plural tables of the supposition situation selection table 171 to make a reference. The supposition situation selecting section 143 selects a supposition situation closest to the present situation of the own vehicle on the basis of the combination of a condition Al indicated in the lower title of the supposition situation selection table A and a condition A2 indicated in the upper title thereof, or selects the next supposition situation selection table to be referred.

The condition Al is a condition based on the present time. The present time is determined whether to be the daytime or the nighttime. The supposition situation selecting section 143 determines that the present time is the daytime when time indicated by the clock 126 is in the range of a predetermined time (for example, from AM 6 o'clock to PM 6 o'clock) and determines that the present time is the nighttime when the present time is time other than the range.

The condition A2 is a condition based on the surrounding temperature or the road surface temperature. The surrounding temperature or the road surface temperature is determined whether to be less than a predetermined threshold value. The supposition situation selecting section 143 determines that the surrounding temperature or the road surface temperature is less than the predetermined threshold value when a temperature detected by the temperature sensor 125 is less than the predetermined threshold value (for example, 0° C.), or determines that the surrounding temperature or the road surface temperature is equal to or more than the predetermined threshold value when a temperature detected by the temperature sensor 125 is equal to or more than the predetermined threshold value.

The supposition situation selecting section 143 selects supposition situation 1, which is a supposition situation closest to the present situation of the own vehicle, on the basis of the supposition situation selection table A when the present time is the nighttime, and the surrounding temperature or the road surface temperature is leas than the predetermined threshold value. Supposition situation 1 is a situation in which the road surface may be frozen since a temperature is low and sunshine does not come at night. Accordingly, supposition situation 1 is the situation in which a driver has to be careful of the road surface status since safety drive may be difficult due to slipping. The supposition situation selecting section 143 supplies the detection process selecting portion 151 with information indicating selection of supposition situation 1.

The detection process selecting portion 151 selects the detection process to be performed in supposition situation 1 on the basis of the detection process selection table 172 FIG. 4 shows an example of the detection process selection table 172. The detection process selection table 172 is a table which defines the detection process to be performed in each supposition situation and a priority order if a plurality of the detection processes are performed, that is, a sequence for performing the detection processes. In the detection process selection table 172, for example, in each supposition situation, detection processes of detecting information on a target which a driver has to be careful of are selected as the detection processes to be performed in each supposition situation, and the priority order of the selected detection processes is determined.

The detection process selecting portion 151 selects the detection process A1 as the detection process to be performed in supposition situation 1 on the basis of the detection process selection table 172. The detection process selecting portion 151 turns the switch 152-1 on and supplies the road surface status detecting portion 161 with information indicating a command for performing the detection process A1 through the switch 152-1.

The road surface status detecting portion 161 performs the detection process A1. Specifically, the road surface status detecting portion 161 acquires the forward side image photographed by the visible light camera 131F from the data pre-processing circuit 142. For an area in which the road surface in the front of the own vehicle is photographed as a target of the forward side image, the road surface status detecting portion 161 detects a frozen status of the road surface using a predetermined technique. The road surface status detecting portion 161 supplies the vehicle control ECU 102 with information indicating the detection result through the output I/F circuit 146. In addition, through the switch 152-1, the road surface status detecting portion 161 supplies the detection process selecting portion 151 with information indicating that the detection process A1 had ended. The detection process selecting portion 151 turns the switch 152-1 off.

The vehicle control ECU 102 controls each element of the own vehicle so as to perform an operation in accordance with the frozen status of the road surface, for example, to make a display or a warning for prompting a driver to be careful, to adjust an appropriate value of a distance between vehicles, which is used for various safety appliances, or to control an operation of ABS (Antilock Brake System).

In this way, in supposition situation 1, the detecting of the frozen status of the road surface is first performed, and then an operation of the own vehicle is controlled in accordance with the detection result since the safety drive is difficult due to the frozen status of the road surface.

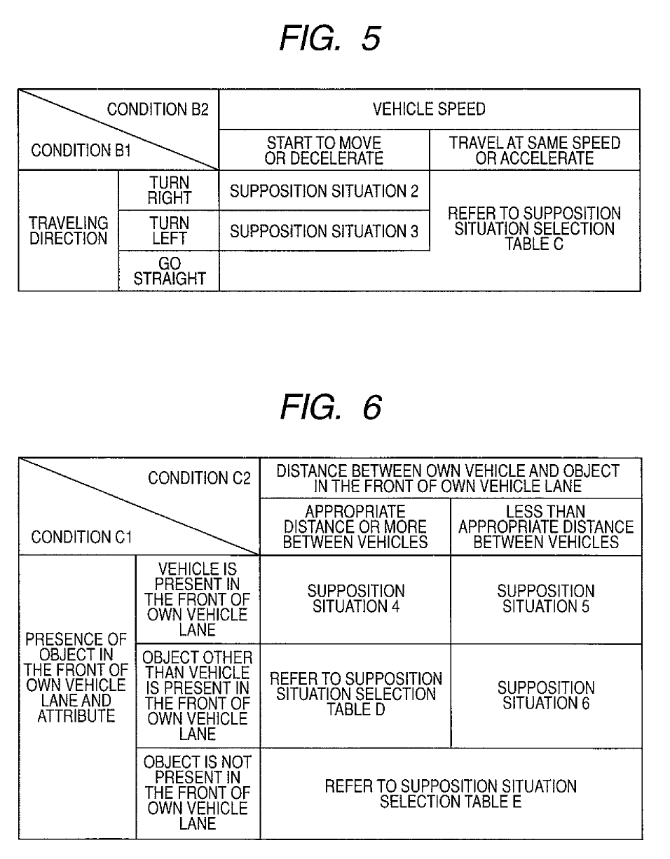

Next, again in FIG. 3, the supposition situation selecting section 143 refers to the supposition situation selection table B shown in FIG. 5 on the basis of the supposition situation selection table A when the present time is the day time, or the surrounding temperature or the road surface temperature is equal to or more than the predetermined threshold value, that is, when there is a low possibility that the safety drive of the own vehicle is difficult due to the frozen status of the road surface. The supposition situation selecting section 143 selects the supposition situation closest to the present situation of the own vehicle on the basis of combination of a condition B1 indicated in the lower title of the supposition situation selection table B and a condition B2 indicated in the upper title hereof, or selects the next supposition situation selection table to be referred.

The condition B1 is a condition based on a traveling direction of the own vehicle, and it is determined that the own vehicle turns right, turns left, and goes straight. The supposition situation selecting section 143 determines that the own vehicle is going to turn right or is turning right when the switch of the direction instructor 122 is configured so that a right lamp blinks. Alternatively, the supposition situation selecting section determines that the own vehicle is going to turn left or turning left when the switch of the direction instructor 122 is configured so that a left lamp blinks. Alternatively, the supposition situation selecting section determines that the own vehicle is going to go straight or is going straight when the switch of the direction instructor 122 is configured so that a lamp does not blink.

The condition B2 is a condition based on variation in the vehicle speed of the own vehicle, and it is determined that the own vehicle starts to move or decelerates, or the own vehicle is traveling at the same speed or accelerates. On the basis of the vehicle speed of the own vehicle detected by the vehicle speed sensor 121, the supposition situation selecting section 143 determines that the own vehicle starts to move when the vehicle speed increases from a state where the vehicle speed is less than a predetermined speed (for example, 10 km/h). Alternatively, the supposition situation selecting section determines that the own vehicle decelerates when the vehicle speed decreases from a predetermined threshold value (for example, 10 km/h) in a case in which the own vehicle is traveling at a predetermined speed or more. Alternatively, the supposition situation selecting section determines that the own vehicle is traveling at the same speed when the variation of the vehicle speed is less than a predetermined threshold value except that the own vehicle starts to move. Alternatively, the supposition situation selecting section determines that the own vehicle accelerates when the vehicle speed becomes equal to or more than a predetermined threshold value in a case in which the own vehicle is traveling at the predetermined speed or more.

The supposition situation selecting section 143 selects supposition situation 2 as the supposition situation closest to the present situation of the own vehicle on the basis of the supposition situation selection table B when it is determined that the own vehicle is going to turn right or is turning right, and the own vehicle starts to move or decelerates. Supposition situation 2 is a situation in which the own vehicle is turning right in an intersection or the like or a situation in which the own vehicle is going to turn right in an intersection or the like. Accordingly, supposition situation 2 is a situation in which a driver has to be careful of persons crossing the road in the front of the own vehicle since there is a possibility of colliding with the persons crossing the road. The supposition situation selecting section 143 supplies the detection process selecting portion 151 with information indicating that the supposition situation selecting section has selected supposition situation 2.

The detection process selecting portion 151 selects the detection process B1 as a detection process to be performed in supposition situation 2 on the basis of the detection process selection table 172 shown in FIG. 4. The detection process selecting portion 151 turns the switch 152-2 on and supplies the forward person detecting portion 162 with information indicating a command for performing the detection process B1 through the switch 152-2.

The forward person detecting portion 162 performs the detection process B1. Specifically, the forward person detecting portion 162 acquires the forward side image photographed by the visible light camera 131F from the data pre-processing circuit 142. On the basis of the forward side image, the forward person detecting portion 162 detects whether a person crossing the road in the front of the own vehicle is present, where the person is located, and which direction the person is crossing, using a predetermined technique. The forward person detecting portion 162 supplies the vehicle control ECU 102 with information indicating the detection result through the output I/F circuit 146. In addition, through the switch 152-2, the forward person detecting portion 162 supplies the information end of the detection process 31 to the detection process selecting portion 151. The detection process selecting portion 151 turns the switch 152-2 off.

The vehicle control ECU 102 controls each element of the own vehicle so as to perform operations in accordance with a situation such as the presence or absence of a person crossing the road in the front of the own vehicle, the location of the person, and the direction in which the person is crossing, for example, an operation for making a display or a warning for prompting a driver to be careful, an operation for restraining acceleration, and an operation for automatically applying a brake.

In this way, in supposition situation 2, since there is a possibility of colliding with the person crossing the road, the detecting of the person crossing the road in the front of the own vehicle is first performed, and then the operations of the own vehicle are controlled in accordance with the detection result.

Again in FIG. 5, the supposition situation selecting section 143 selects supposition situation 3 as the supposition situation closest to the present situation of the own vehicle on the basis of the supposition situation selection table B when the own vehicle is going to turn left or is turning left, and the own vehicle starts to move or decelerates. Supposition situation 3 is a situation in which the own vehicle is turning left or is going to turn left in an intersection or the like. Accordingly, supposition situation 3 is a situation in which a driver has to be careful of, first, a bike traveling at the left side of the own vehicle and to be careful of, next, a person crossing the road in the front of the own vehicle since there is a possibility that the own vehicle hits the bike traveling at the left side or the person crossing the road. The supposition situation selecting section 143 supplies the detection process selecting portion 151 with information indicating that the supposition situation selecting section has selected supposition situation 3.

The detection process selecting portion 151 selects the detection processes B1 and C as the detection processes to be performed in supposition situation 3 on the basis of the detection process selection table 172 shown in FIG. 4. The detection process C is a process which is performed to detect the bike travels at the left side of the own vehicle using the left side image photographed by the visible light camera 131L by use of the left-side bike detecting portion 163. On the basis of the priority order indicated in the detection process selection table 172, the detection process selecting portion 151 first turns the switch 152-3 on, and supplies the left-side bike detecting portion 163 with information indicating a command for performing the detection process C through the switch 152-3.

The left-side bike detecting portion 163 performs the detection process C. Specifically, the left-side bike detecting portion 163 acquires the left-side image photographed by the visible light camera 131L from the data pre-processing circuit 142. On the basis of the left-side image, the left-side bike detecting portion 163 detects whether the bike traveling at the left side of the own vehicle is present, where the bike is located, and which direction the bike is traveling, using a predetermined technique. The left-side bike detecting portion 163 supplies the vehicle control ECU 102 with information indicating the detection result through the output I/F circuit 146. In addition, through the switch 152-3, the left-side bike detecting portion 163 supplies the detection process selecting portion 151 with information indicating that the detection process C has ended. The detection process selecting portion 151 turns the switch 152-3 off.

The vehicle control ECU 102 controls each element of the own vehicle so as to perform operations in accordance with a situation such as the presence or absence of the bike traveling at the left side of the own vehicle, the location of the bike, and the direction in which the bike is traveling, for example, an operation for making a display or a warning for prompting a driver to be careful, an operation for restraining acceleration, and an operation for automatically applying a brake.

Next, like the process in supposition situation 2, the detection process 31 and a process in accordance with the detection process B are performed.

In this way, in supposition situation 3, the detecting of the bike traveling at the left side of the own vehicle is first performed and operations of the own vehicle are controlled in accordance with the detection result since there is a possibility of hitting the bike traveling at the left side of the own vehicle, which is a blind side of a driver. In addition, like supposition situation 2, the detecting of the person crossing the road in the front of the own vehicle is secondly performed, and the operations of the own vehicle are controlled in accordance with the detection result since there is a possibility of colliding with the person crossing the road.

Next, again in FIG. 5, the supposition situation selecting section 143 refers to a supposition situation selection table C shown in FIG. 6 on the basis of the supposition situation selection table B when it is determined that the own vehicle is going to go straight or going straight, or the own vehicle is traveling at the same speed or accelerates. The supposition situation selecting section 143 selects the supposition situation closest to the present situation of the own vehicle on the basis of combination of a condition C1 indicated in the lower title of the supposition situation selection table C and a condition C2 indicated in the upper title thereof, or selects the next supposition situation selection table to be referred.

The condition C1 is a condition based on whether a forward object is present within a lane (hereinafter, referred to as an own vehicle lane) in which the own vehicle is traveling and based on an attribute of the object. In addition, it is determined whether a vehicle within the own vehicle lane is present, an object in the front of the own vehicle lane other than the vehicle is present, or whether an object in the front of the own vehicle lane is not present. On the basis of the detection result of whether the object in the front of the own vehicle lane is present and the detection result of the attribute of the object by use of the radar section 123, the supposition situation selecting section 143 determines whether the vehicle within the own vehicle lane is present, the object in the front of the own vehicle lane other than the vehicle is present, or whether the object in the front of the own vehicle lane is not present.

The condition C2 is a condition based on a distance between the own vehicle and the forward object within the own vehicle lane, and it is determined whether the distance between the own vehicle and the forward object within the own vehicle lane is an appropriate distance or more between vehicles. The supposition situation selecting section 143 calculates the appropriate distance between vehicles according to the vehicle speed of the own vehicle detected by the vehicle sensor 121 to determine whether the distance between the own vehicle and the forward object within the own vehicle lane detected by the radar section 123 is the appropriate distance or more between vehicles.

The supposition situation selecting section 143 selects supposition situation 4 as the supposition situation closest to the present situation of the own vehicle on the basis of the supposition situation selection table C when it is determined that a vehicle is present in the front of the own vehicle lane and the distance between the own vehicle and the vehicle is the appropriate distance or more between vehicles. Supposition situation 4 is a situation in which the distance between the own vehicle and the forward vehicle within the own vehicle lane is large. Accordingly, in supposition situation 4, a driver has to be careful of, first, an interrupting vehicle and to be careful of, next, the forward vehicle since there is a possibility that another vehicle can interrupt between the own vehicle and the forward vehicle and the own vehicle collides with the interrupting vehicle. The supposition situation selecting section 143 supplies the detection process selecting portion 151 with information indicating that the supposition situation selecting section has selected supposition situation 4.

The detection process selecting portion 151 selects the detection processes D1 and E as the detection processes to be performed in supposition situation 4 on the basis of the detection process selection table 172 shown in FIG. 4. On the basis of the priority order indicated in the detection process selection table 172, the detection process selecting portion 151 first turns the switch 152-4 on, and supplies the interrupt vehicle detecting portion 164 with information indicating a command for performing the detection process D1 through the switch 152-4.

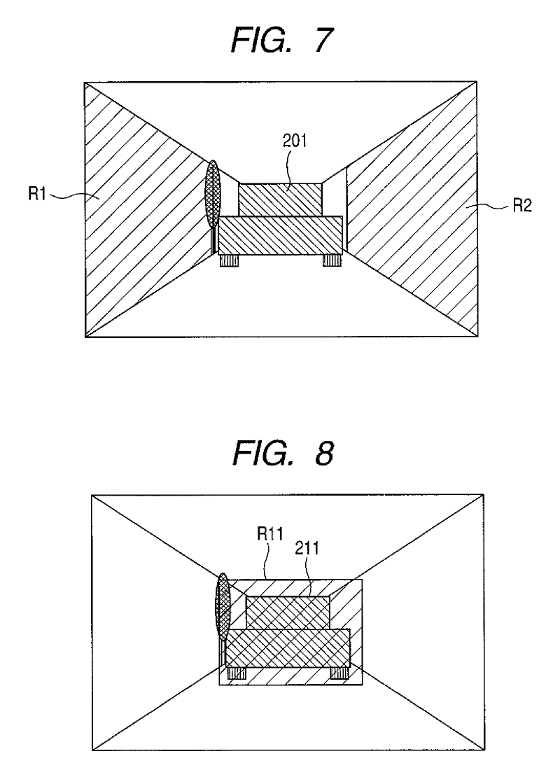

The interrupt vehicle detecting portion 164 performs the detection process D1. Specifically, the interrupt vehicle detecting portion 164 acquires data indicating the location of the own vehicle lane detected by the radar section 123 from the situation information input I/F circuit 141, and acquires the forward side image photographed by the visible light camera 131F from the data pre-processing circuit 142. On the basis of the forward side image, the interrupt vehicle detecting portion 164 detects whether the interrupting vehicle is present, where the interrupting vehicle is located, and which direction the interrupting vehicle is traveling, using a predetermined technique. For example, as shown in FIG. 7, the interrupt vehicle detecting portion 164 performs the detection process D1 for areas R1 and R2 within the forward side image, which are between the own vehicle and a forward vehicle 201 and an outside area from the own vehicle lane. The interrupt vehicle detecting portion 164 supplies the vehicle control ECU 102 with information indicating the detection result through the output I/F circuit 146. In addition, through the switch 152-4, the interrupt vehicle detecting portion 164 supplies the detection process selecting portion 151 with information indicating that the detection process D1 has ended. The detection process selecting portion 151 turns the switch 152-4 off.

The vehicle control ECU 102 controls each element of the own vehicle so as to perform operations in accordance with a situation such as the presence or absence of the interrupting vehicle, the location of the interrupting vehicle, and the direction in which the interrupting vehicle is traveling, for example, an operation for making a display or a warning for prompting a driver to be careful, an operation for restraining acceleration, and an operation for automatically applying a brake.

Next, on the basis of the priority order indicated in the detection process selection table 172, the detection process selecting portion 151 turns the switch 152-5 on, and supplies the forward vehicle location detecting portion 165 with information indicating a command for performing a detection process E through the switch 152-5.

The forward vehicle location detecting portion 165 performs the detection process E. Specifically, the forward vehicle location detecting portion 165 acquires data indicating the location of the own vehicle lane detected by the radar section 123 from the situation information input I/F circuit 141 and acquires the forward side image photographed by the visible light camera 131F from the data pre-processing circuit 142. On the basis of the forward side image, the forward vehicle location detecting portion 165 detects the location and the vehicle width of the forward vehicle using a predetermined technique. At this time, the forward vehicle location detecting portion 165 performs the detection process E for an area R11 of the forward side image including the forward vehicle 211 within the own vehicle lane, as shown in FIG. 8. On the basis of the location and the vehicle width of the forward vehicle, the forward vehicle location detecting portion 165 calculates an amount of avoidance in order to avoid collision with the forward vehicle. The forward vehicle location detecting portion 165 supplies the vehicle control ECU 102 with information indicating the detection result and the amount of avoidance through the output I/F circuit 146. In addition, through the switch 152-5, the forward vehicle location detecting portion 165 supplies the detection process selecting portion 151 with information indicating that the detection process E has ended. The detection process selecting portion 151 turns the switch 152-5 off.

The vehicle control ECU 102 controls each element of the own vehicle so as to perform operations in accordance with the location and the vehicle width of the forward vehicle and the amount of avoidance in order to avoid the collision with the forward vehicle, for example, an operation for making a display or a warning for prompting a driver to be careful, an operation for restraining acceleration, and an operation for automatically applying a brake.

In this way, since there is a possibility that the own vehicle collides with the interrupting vehicle in supposition situation 4, the detecting of the interrupting vehicle is firstly performed, and the operation of the own vehicle is controlled in accordance with the detection result. In addition, since there is a possibility that the own vehicle collides with the forward vehicle existing in the front of the own vehicle lane, the detecting of the forward vehicle and the calculating of the amount of avoidance is secondly performed, and the operation of the own vehicle is performed in accordance with the detection result.

Again in FIG. 6, the supposition situation selecting section 143 selects supposition situation 5 as a supposition situation closest to the present situation of the own vehicle on the basis of the supposition situation selection table C when it is determined that a vehicle is present in the front of the own vehicle lane and the distance between the own vehicle and the forward vehicle is less than the appropriate distance between vehicles. Supposition situation 5 is a situation in which the distance between the own vehicle and the forward vehicle within the own vehicle lane is narrow. Accordingly, for example, if the forward vehicle applies an urgent brake, the own vehicle can collide the forward vehicle. Therefore, supposition situation 5 is the situation in which a driver has to be careful of, first, the forward vehicle and to be careful of, next, the interrupting vehicle. The supposition situation selecting section 143 supplies the detection process selecting portion 151 with information indicating that the supposition situation selecting section has selected supposition situation 5.

The detection process selecting portion 151 selects the detection processes D1 and E as the detection processes to be performed in supposition situation 5 on the basis of the detection process selection table 172 shown in FIG. 4. Afterward, contrary to a case of supposition situation 4, the detection process E and the detection process D1 are sequentially performed, and the process corresponding to the detection result is performed.

In this way, in supposition situation 5, since there is a possibility that the own vehicle collides with the forward vehicle and there is a low possibility that a vehicle is interrupting between the own vehicle and the forward vehicle, the detecting of the forward vehicle and the calculating of the amount of avoidance are firstly performed, and the detecting of the interrupting vehicle is secondly performed, comparing with supposition situation 4,

Again in FIG. 6, the supposition situation selecting section 143 selects supposition situation 6 as a situation closest to the present situation of the own vehicle on the basis of the supposition situation selection table C when an object other than a vehicle is present in the front of the own vehicle lane and the distance between the own vehicle and the object is less than the appropriate distance between vehicles. Supposition situation 6 is a situation in which the object is present at a location close to the front of the own vehicle. Accordingly, unless the own vehicle avoids the object, there is a possibility that the own vehicle hits the object. Therefore, supposition situation 6 is the situation in which a driver has to be most careful of the object in the front of the own vehicle. The supposition situation selecting section 143 supplies the detection process selecting portion 151 with information indicating that the supposition situation selection section has selected supposition situation 6.

The detection process selecting portion 151 selects a detection process F as a detection process to be performed in supposition situation 6 on the basis of the selection process selection table 172 shown in FIG. 4. The detection process selecting portion 151 turns the switch 152-6 on and supplies the object location detecting portion 166 with information indicating a command for performing the detection process F through the switch 152-6.

The object location detecting portion 166 performs the detection process F. Specifically, the object location detecting portion 166 acquires data indicating the location of the own vehicle lane detected by the radar section 123 from the situation information input I/F circuit 141 and acquires the forward side image photographed by the visible light camera 131F from the data pre-processing circuit 142. On the basis of the forward side image, the object location detecting portion 166 detects the location and size of the object present in the front of the own vehicle lane. At this time, the object location detecting portion 166 performs the detection process F for, for example, an area within the forward side image including the object present in the own vehicle lane. On the basis of the location and size of the object, especially the width of the object in a transverse direction, the object location detecting portion 166 calculates an amount of avoidance to avoid collision with the object. The object location detecting portion 166 supplies information indicating the detection result and the amount of avoidance to the vehicle control ECU 102 through the output I/F circuit 146. In addition, through the switch 152-6, the object location detecting portion 166 supplies the detection process selecting portion 151 with information indicating that the detection process F has ended. The detection process selecting portion 151 turns the switch 152-6 off.

The vehicle control ECU 102 controls each element of the own vehicle so as to perform operations in accordance with the position and the size of the forward object and the amount of avoidance in order to avoid the collision with the forward object, for example, an operation for making a display or a warning for prompting a driver to be careful, an operation for restraining acceleration, an operation for controlling a traveling direction of the own vehicle, and an operation for automatically applying a brake.

In this way, in supposition situation 6, since there is a high possibility that the own vehicle hits the object in the front of the own vehicle, the detecting of the location and size of the object and the calculating of the amount of avoidance are first performed, and an operation of the own vehicle is controlled in accordance with the detection result.

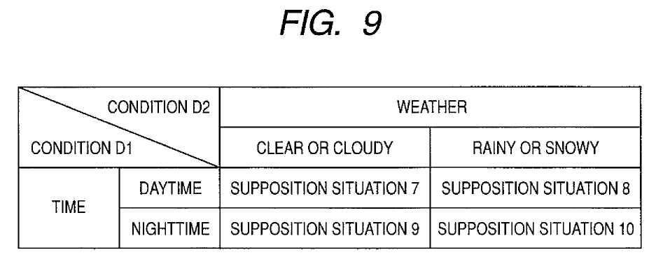

Again in FIG. 6, next, the supposition situation selecting section 143 refers to a supposition situation selection table D shown in FIG. 9 when the object other than a vehicle is present in the front of the own vehicle lane and the distance between the own vehicle and the object is the appropriate distance or more between vehicles. The supposition situation selecting section 143 selects a supposition situation closest to the present situation of the own vehicle on the basis of combination of a condition D1 indicated in the lower title of the supposition situation selection table D and a condition D2 indicated in the upper title thereof.

The condition D2 is a condition based on surrounding weather, and it is determined that weather is clear or cloudy, or rainy or snowy. The supposition situation selecting section 143 determines that the weather is rainy or snowy when an amount of rain detected by the rain sensor 124 is equal to or more than a predetermined threshold value (for example, 0.1 mm/h), and determines that the weather is clear or cloudy when the amount of rain is less than the predetermined threshold value.

The condition D1 is the same condition as the condition A1 shown in FIG. 3.

The supposition situation selecting section 143 selects supposition situation 7 as a supposition situation closest to the present situation of the own vehicle on the basis of the supposition situation selection table D when it is determined that the present time is the daytime and the weather is clear or cloudy. Supposition situation 7 is a situation in which, for example, an object such as a person crossing a road is present away from the front of the own vehicle lane. Accordingly, since there is a possibility that the own vehicle collide with the object, supposition situation 7 is the situation in which a driver has to take the most care of a forward object, and particularly, the forward object is required to check a person or no. In addition, supposition situation 7 is the situation in which there is a low possibility that a person holds an umbrella when the forward object within the own vehicle lane is the person. The supposition situation selecting section 143 supplies the detection process selecting portion 151 with information indicating that the supposition situation selecting section has selected the supposition situation 7.

The detection process selecting portion 151 selects detection processes B2 and F as detection processes to be performed in supposition situation 7 on the basis of the detection process selection table 172 shown in FIG. 4. On the basis of the priority order shown in the detection process selection table 172, the detection process selecting portion 151 first turns the switch 152-2 on and supplies the forward person detecting portion 162 with information indicating a command for performing the detection process B2 through the switch 152-2.

The forward person detecting portion 162 performs the detection process B2. Specifically, the forward person detecting portion 162 acquires data indicating the location of the own vehicle lane detected by the radar section 123 from the situation information input I/F circuit 141 and acquires the forward side image photographed by the visible light camera 131F from the data pre-processing circuit 142. On the basis of the forward side image, the forward person detecting portion 162 detects a person present in the front of the own vehicle lane using a predetermined technique. At this time, the forward person detecting portion 162, for example, performs the detection process B2 for an area within the forward side image including an object present within the own vehicle lane. The forward person detecting portion 162 supplies the vehicle control ECU 102 with information indicating whether the forward object present within the own vehicle lane is a person or not through the output I/F circuit 146. In addition, through the switch 152-2, the forward person detecting portion 162 supplies the detection process selecting portion 151 with information indicating that the detection process B2 has ended. The detection process selecting portion 151 turns the switch 152-2 off.

The vehicle control ECU 102 controls each element of the own vehicle so as to perform operations in accordance with a case in which the forward object is a person, for example, an operation for making a display or a warning for prompting a driver to be careful and the like.

Next, like the operations of supposition situation 6, the detection process F and the operations in accordance with the detection result of the detection process F are performed.

In this way, in supposition situation 7, since the own vehicle and the forward object within the own vehicle lane is away from each other, the detection whether the forward object is a person that collision therewith results in serious damage is firstly performed, and an operation of the own vehicle is controlled in accordance with the detection result. Next, the detecting of the location and size of the forward object and the calculating of the amount of avoidance are performed, and an operation of the own vehicle is controlled in accordance with the detection result.

Again in FIG. 9, the supposition situation selecting section 143 selects supposition situation 8 as a supposition situation closest to the present situation of the own vehicle on the basis of the supposition situation selection table D when it is determined that the present time is the daytime and the weather is rainy or snowy. Like supposition situation 7, supposition situation 8 is a situation in which an object such as a person crossing a road is present at a location away from the own vehicle lane. In addition, supposition situation 8 is a situation in which there is a high possibility that a person holding an umbrella is present. The supposition situation selecting section 143 supplies the detection process selecting portion 151 with information indicating that the supposition situation selecting section has selected supposition situation 8.

The detection process selecting portion 151 selects detection processes B3 and F as detection processes to be performed in supposition situation 8 on the basis of the detection process selection table 172 shown in FIG. 4. On the basis of the priority order shown in the detection process selection table 172, the detection process selecting portion 151 first turns the switch 152-2 on, and supplies the forward person detecting portion 162 with information indicating a command for performing the detection process B3 through the switch 152-2.

The forward person detecting portion 162 performs the detection process B3. Specifically, the forward person detecting portion 162 acquires data indicating the location of the own vehicle lane detected by the radar section 123 from the situation information input I/F circuit 141, and acquires the forward side image photographed by the visible light camera 131F from the data pre-processing circuit 142. On the basis of the forward side image, the forward person detecting portion 162 detects a person present in the front of the own vehicle lane using a predetermined technique. At this time, the forward person detecting portion 162, for example, performs the detection process B3 for an area within the forward side image including the object present within the own vehicle lane. In addition, the forward person detecting portion 162 adds a person holding an umbrella as a detecting target and performs the detection process B3 since the person holding the umbrella is different from other persons. The forward person detecting portion 162 supplies the vehicle control ECU 102 within formation indicating whether the forward object within the own vehicle lane is a person or not through the output I/F circuit 146. In addition, through the switch 152-2, the forward person detecting portion 162 supplies the detection process selecting portion 151 with information indicating that the detection process B3 has ended. The detection process selecting portion 151 turns the switch 152-2 off.

The vehicle control ECU 102 controls each element of the own vehicle so as to perform operations in accordance with a case in which the forward object is a person, for example, an operation for making a display or a warning for prompting a driver to be careful and the like.

Next, like the processes of supposition situation 6, the detection process F and operations in accordance with the detection result of the detection process F are performed.

In this way, in supposition situation 8, the detecting of the forward person is performed by adding the person holding the umbrella since there is a high possibility that the person holds the umbrella, comparing with supposition situation 7.

Again in FIG. 9, the supposition situation selecting section 143 selects supposition situation 9 as a supposition situation closest to the present situation of the own vehicle on the basis of the supposition situation selection table D when the present time is the nighttime and the weather is clear or cloudy. Like supposition situation 7, supposition situation 9 is a situation in which, for example, an object such as a person or the like crossing a road is present at a location away from the front of the own vehicle lane. In addition, supposition situation 9 is the situation in which there is a low possibility that the person holds an umbrella if the object in the front of the own vehicle lane is the person. In addition, supposition situation 9 is the situation in which the detecting of the person is difficult using the forward side image photographed by the visible light camera 131F since the forward side image is dark. The supposition situation selecting section 143 supplies the detection process selecting portion 151 with information indicating that the supposition situation selecting section has selected supposition situation 9.

The detection process selecting portion 151 selects detection processes B4 and F as the detection processes to be performed in supposition situation 9 on the basis of the detection process selection table 172 shown in FIG. 4. On the basis of the priority order shown in detection process selection table 172, the detection process selecting portion 151 first turns the switch 152-2 on and supplies the forward person detecting portion 162 with information indicating a command for performing the detection process B4 through the switch 152-2.

The forward person detecting portion 162 performs the detection process B4. Specifically, the forward person detecting portion 162 acquires data indicating the location of the own vehicle lane detected by the radar section 123 from the situation information input I/F circuit 141 and acquires the forward side image photographed by the near-infrared light camera 132 from the data pre-processing circuit 142. The forward person detecting portion 162 detects a person present in the front of the own vehicle lane using a predetermined technique on the basis of the forward side image photographed using light at least from the visible light area to the near-infrared light area. At this time, for example, the forward person detecting portion 162 performs the detection process B4 for the area within the forward side image including the object present in the own vehicle lane. The forward person detecting portion 162 supplies the vehicle control ECU 102 through the output I/F circuit 146 with information indicating whether the object present in the own vehicle lane is a person or not. In addition, through the switch 152-2, the forward person detecting portion 162 supplies the detection process selecting portion 151 with information indicating that the detection process B4 has ended. The detection process selecting portion 151 turns the switch 152-2 off.

The vehicle control ECU 102 controls each element of the own vehicle so as to perform operations in accordance with a case in which the forward object is a person, for example, an operation for making a display or a warning for prompting a driver to be careful and the like.

Next, like the operations of supposition situation 6, the detection process F and operations in accordance with the detection result of the detection process F are performed.

In this way, in supposition situation 9, the detecting of the forward person is performed using the forward side image photographed by the near-infrared light camera 132 since the surrounds is dark in the nighttime, comparing supposition situation 7.

Again in FIG. 9, the supposition situation selecting section 143 selects supposition situation 10 as a supposition situation closest to the present situation of the own vehicle on the basis of the supposition situation selection table D when the present time is the nighttime and the weather is rainy or snowy. Like supposition situation 7, supposition situation 10 is a situation in which, for example, the object such as a person crossing a road is present at a location away from the front of the own vehicle lane. In addition, supposition situation 10 is the situation in which there is a high possibility that the person holds an umbrella. In addition, supposition situation 10 is the situation in which the detecting of the person using the forward side image photographed by the visible light camera 131F and the forward side image photographed by the near-infrared light camera 132 is difficult due to a glare phenomenon generated by light such as headlight of a facing vehicle in the nighttime and in bad weather. The supposition situation selecting section 143 supplies the detection process selecting portion 151 with information indicating that the supposition situation selecting section has selected supposition situation 10.

The detection process selecting portion 151 selects detection processes B5 and F as detection processes to be performed in supposition situation 10 on the basis of the detection process selection table 172 shown in FIG. 4. On the priority order shown in the detection process selection table 172, the detection process selecting portion 151 first turns the switch 152-2 on, and supplies the forward person detecting portion 162 with information indicating a command for performing the detection process B5 through the switch 152-2.

The forward person detecting portion 162 performs the detection process B5. Specifically, the forward person detecting portion 162 acquires data indicating the location of the own vehicle lane detected by the radar section 123 from the situation information input I/F circuit 141 and the forward side image photographed by the far-infrared light camera 133 from the data pre-processing circuit 142. The forward person detecting portion 162 detects a person present in the front of the own vehicle lane using a predetermined technique on the basis of the forward side image photographed using light at least from the visible light area to the far-infrared light area. At this time, for example, the forward person detecting portion 162 performs the detection process B5 for the area within the forward side image including the object present in the own vehicle lane. In addition, the forward person detecting portion 162 performs the detection process B5 by adding a case in which a person holds an umbrella, like the detection process B3. The forward person detecting portion 162 supplies the vehicle control ECU 102 through the output I/F circuit 146 with information indicating whether the object present in the own vehicle lane is a person or not. In addition, through the switch 152-2, the forward person detecting portion 162 supplies the detection process selecting portion 151 with information indicating that the detection process B5 has ended. The detection process selecting portion 151 turns the switch 152-2 off.

The vehicle control ECU 102 controls each element of the own vehicle so as to perform operations in accordance with a case in which the forward object is a person, for example, an operation for making a display or a warning for prompting a driver to be careful and the like.

Next, like the operations of supposition situation 6, the detection process F and operations in accordance with the detection result of the detection process F are performed.

In this way, the detecting of the forward person is performed in supposition situation 10 by using the forward side image photographed by the far-infrared light camera 133 since a forward view range becomes more deteriorated, and by adding a case in which a person holds an umbrella since there is a high possibility that the person holds the umbrella, comparing with supposition situation 9.

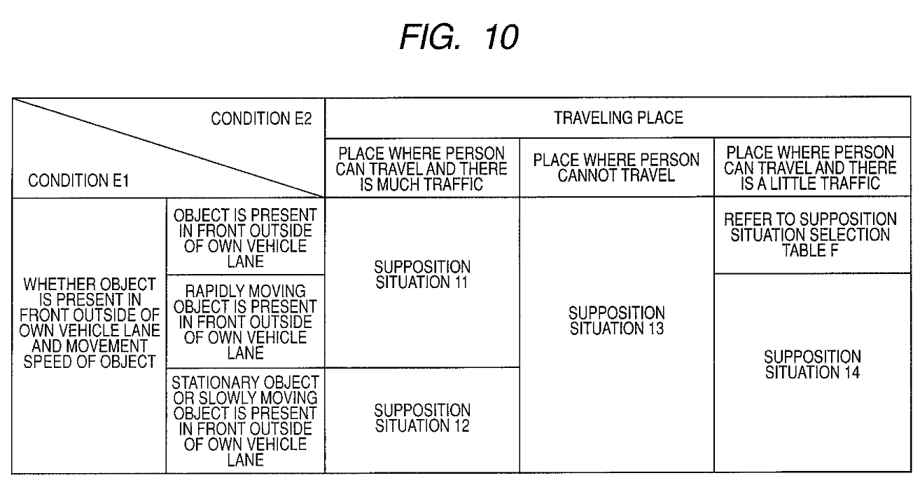

Again in FIG. 6, next, the supposition situation selecting section 143 refers to a supposition situation selection table E shown in FIG. 10 when it is determined that the object is not present in the front of the own vehicle lane. The supposition situation selecting section 143 selects a supposition situation closest to the present situation of the own vehicle on the basis of combination of a condition E1 indicated in the lower title of the supposition situation selection table E and a condition E2 indicated in the upper title thereof, or selects the next supposition situation selection table to be referred.

The condition E1 is a condition based on whether a forward object is present outside the own vehicle lane and how much rapidly the object is moving. In addition, it is determined whether the forward object is not present outside the own vehicle lane, whether a rapidly moving object is present in the front outside of the own vehicle lane, or whether a slowly moving object or a stationary object is present in the front outside of the own vehicle lane. On the basis of the detection result of the radar section 123 with regard to whether the object is present in the front outside of the own vehicle lane and how much rapidly the object is moving, the supposition situation selecting section 143 determines whether the object is not present in the front outside of the own vehicle lane, whether the rapidly moving object is moving (for example, moving at 40 km/h or more) in the front outside of the own vehicle lane, or whether the slowly moving object or the stationary moving object (for example, the object moving at less than 40 km/h) is present in the front outside of the own vehicle lane.

The condition E2 is a condition based on the place where the own vehicle travels. In addition, it is determined whether the own vehicle is traveling in a place where a bicycle or a person such as a pedestrian cannot travel, whether the own vehicle is traveling in a place where a person can travel and there is much traffic of persons or vehicles, or whether the own vehicle is traveling in a place where a person can travel and there is a little traffic of persons or vehicles. The supposition situation selecting section 143 determines that the own vehicle is traveling in a place where persons cannot travel when it is detected by the car navigation system 127 that the own vehicle is traveling in a place where persons is prohibited from traveling such as a highway, a road for only a vehicle, or the like. In addition, the supposition situation selecting section determines that own vehicle is traveling in a place where a person can travel and there is much traffic when it is detected that the own vehicle is traveling in an urban district, a shopping district, or the like. In addition, the supposition situation selecting section determines that own vehicle is traveling in a place where a person can travel and there is a little traffic when it is detected that the own vehicle is traveling in a suburban district.

The supposition situation selecting section 143 selects supposition situation 11 as a supposition situation closest to the present situation of the own vehicle on the basis of the supposition situation selection table E when it determines that the object is not present in the front outside of the own vehicle lane and the own vehicle is traveling in the place where a person can travel and there is much traffic, or it is determined that the rapidly moving object is present in the front of the own vehicle and the own vehicle is traveling in the place where a person can travel and there is much traffic. Supposition situation 11 is a situation in which there is much traffic of vehicles or persons and there is a low possibility that a person is present in the front outside of the own vehicle lane. Accordingly, supposition situation Ti is the situation in which a driver has to be careful of, first, an interrupting vehicle and, next, a rushing-in person since there is a possibility that the own vehicle collides with the vehicle which abruptly interrupts the front of the own vehicle or collides with the person who abruptly rushes in the front of own vehicle. The supposition situation selecting section 143 supplies the detection process selecting portion 151 with information indicating the supposition situation selecting section selects supposition 11.

The detection process selecting portion 151 selects detection processes B6 and D2 as detection processes to be performed in supposition situation 11 on the basis of the detection process selection table 172 shown in FIG. 4. On the basis of the priority order shown in the detection process selection table 172, the detection process selecting portion 151 first turns the switch 152-4 on and supplies the interrupt vehicle detecting portion 164 with information indicating a command for performing the detection process D2 through the switch 152-4.

The interrupt vehicle detecting portion 164 performs the detection process D2. Specifically, the interrupt vehicle detecting portion 164 acquires data indicating the vehicle speed of the own vehicle detected by the vehicle speed sensor 121 and data indicating the location of the own vehicle lane detected by the radar section 123 from the situation information input I/F circuit 141, and acquires the forward side image photographed by the visible light camera 131F from the data pre-processing circuit 142. On the basis of the forward side image, the interrupt vehicle detecting portion 164 detects whether the interrupting vehicle is present, where the interrupting vehicle is located, what size the interrupting vehicle is, which direction the interrupting vehicle is moving, using a predetermined technique. At this time, the interrupt vehicle detecting portion 164 adjusts an area of the forward side image as a target of the detection process D2 in accordance with the vehicle speed of the own vehicle.

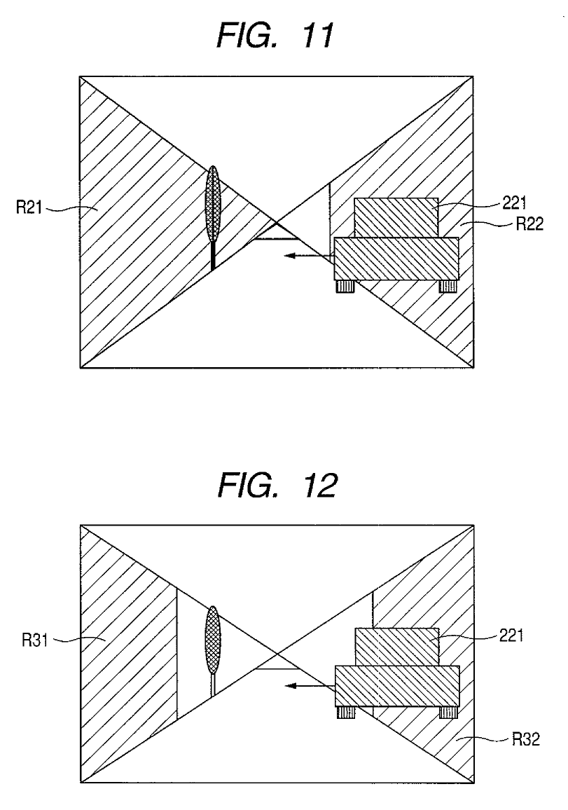

FIGS. 11 and 12 are diagrams illustrating an example of the area as the target of the detection process D2. FIG. 11 shows an example of the detection area when the vehicle speed of the own vehicle is rapid, comparing FIG. 12. In addition, FIG. 12 shows an example of the detection area when the vehicle speed of the own vehicle is slow, comparing with FIG. 11. In the detection process D2, it is necessary to detect the interrupting vehicle which is located more away from the own vehicle since the distance necessary for the own vehicle to stop becomes longer as the vehicle speed becomes faster. Accordingly, detection areas R21 and R22 of FIG. 11 are configured so as to be larger than detection areas R31 and R32 of FIG. 12 in order to detect the interrupting vehicle which is located more away from the own vehicle. That is, in the detection process D2, the detection areas are configured so that a location which is away more than the front outside of the own vehicle lane is included as the vehicle speed of the own vehicle becomes faster.

The interrupt vehicle detecting portion 164 supplies to the vehicle control ECU 102 with information indicating the detection result through the output I/F circuit 146. In addition, through the switch 152-4, the interrupt vehicle detecting portion 164 supplies the detection process selecting portion 151 with information indicating that the detection process D2 has ended. The detection process selecting portion 151 turns the switch 152-4 off.

The vehicle control ECU 102 controls each element of the own vehicle so as to perform operations in accordance with the presence or absence of the interrupt vehicle, the location, the size, the moving direction, and the like, for example, an operation of making a display or a warning for prompting a driver to be careful, and an operation for automatically applying a brake.

Next, on the basis of the priority order shown in the detection process selection table 172, the detection process selection portion 151 turns the switch 152-2 on and supplies the forward person detecting portion 162 with information indicating a command for performing the detection process B6 through the switch 152-2.

The forward person detecting portion 162 performs the detection process B6. Specifically, the forward person detecting portion 162 acquires data indicating the vehicle speed of the own vehicle detected by the vehicle speed sensor 121 and data indicating the location of the own vehicle lane detected by the radar section 123 from the situation information input I/F circuit 141, and acquires the forward side image photographed by the visible light camera 131F from the data pre-processing circuit 142. On the basis of the forward side image, the forward person detecting portion 162 detects whether a person present in the front of the own vehicle lane, where the person is located, which direction the person is moving, using a predetermined technique. At this timer the forward person detecting portion 162 adjusts an area of the forward side image as a target of the detection process B6 in accordance with the vehicle speed of the own vehicle.

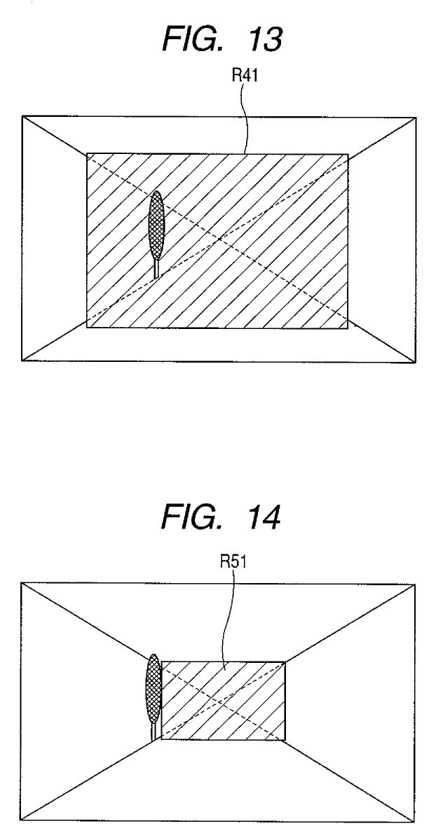

FIGS. 13 and 14 are diagrams illustrating an example of detection areas of the forward side image as a target of the detection process 86. FIG. 13 shows an example of the detection area in a case in which the vehicle speed of the own vehicle is slow, comparing with FIG. 14. In addition, FIG. 14 shows an example of detection area in a case in which the vehicle speed of the own vehicle is rapid, comparing with FIG. 13. It is necessary to detect that a person closer to the own vehicle is rushing in since there is a possibility that the own vehicle collides with the rushing-in person closer to the own vehicle as the vehicle speed becomes slower. Accordingly, a detection area R41 shown in FIG. 13 is configured so as to be larger than the detection area R51 shown in FIG. 14 so that the rushing-in person closer to the own vehicle is detected. That is, in the detection process B6, the detection area is configured so that the location closer to the front of the own vehicle is included as the vehicle speed of the own vehicle becomes slower.

In addition, it is necessary to detect the rushing-in person more away from the own vehicle since the distance necessary for the own vehicle to stop becomes longer as the vehicle speed of the own vehicle becomes faster. Moreover, it is desirable that a resolution of an image used in the detection process B6 is higher since a detection target becomes smaller in the area which is away from the own vehicle. On the other hand, necessity to detecting the rushing-in person located away from the own vehicle becomes decreased since the distance necessary for the own vehicle to stop becomes shorter as the vehicle speed of the own vehicle is slower. Accordingly, it is possible to control the resolution of the image used in the detection process B6 so as to be low to some extent since a detection target becomes increased to some extent. Therefore, the forward person detecting portion 162 allows the data pre-processing portion 142 to convert the resolution of the forward side image so that the resolution is higher as the vehicle speed becomes faster and the resolution is lower as the vehicle speed becomes slower. Afterward, the forward person detecting portion 162 acquires the forward side image used in the detection process B6.

The forward person detecting portion 162 supplies the vehicle control ECU 102 with information indicating the detection result through the output I/F circuit 146. In addition, through the switch 152-2, the forward person detecting portion 162 supplies the detection process selecting portion 151 with information indicating that the detection process B6 has ended. The detection process selecting portion 151 turns the switch 152-2 off.

The vehicle control ECU 102 controls each element of the own vehicle so as to perform operations in accordance with the presence or absence of the forward person, the location of the forward person, the direction in which the forward person is moving, and the like, for example, an operation of making a display or a warning for prompting a driver to be careful, an operation for restraining acceleration, and an operation for automatically applying a brake.

In this way, in supposition situation 11, the detecting of the interrupting vehicle is firstly performed and the detecting of the person rushing in the front of the own vehicle is secondly performed since an object which seems to be a person is not detected in the front outside of the own vehicle lane.

Again in FIG. 10, the supposition situation selecting section 143 selects supposition situation 12 as a supposition situation closest to the present situation of the own vehicle on the basis of the supposition situation selection table E when it determines that a stationary object or an object moving the same speed is present in the front outside of the own vehicle lane and the own vehicle is traveling in a place where a person can travel and there is much traffic. Supposition situation 12 is a situation in which there is a high possibility that there is much traffic of vehicles or persons and a person is present in the front outside of the own vehicle lane. Accordingly, supposition situation 12 is the situation in which a driver has to be careful of, first, the abruptly rushing-in person and, next, the interrupting vehicle since there is a possibility that the own vehicle collides with the vehicle abruptly interrupting in the front of the own vehicle or there is a higher possibility that the own vehicle hits the person abruptly rushing in, comparing with supposition situation 11. The supposition situation selecting section 143 supplies the detection process selecting portion 151 with information indicating that the supposition situation selecting section has selected supposition situation 12.

The detection process selecting portion 151 selects the detection processes B6 and D2 as the detection processes to be performed in supposition situation 12 on the basis of the detection process selection table 172 shown in FIG. 4. Afterward, contrary to the case of supposition situation 11, the detection process B6 and the detection process D2 are sequentially performed, and an operation corresponding to the detection result is performed.

In this way, in supposition situation 12, the detecting of the person abruptly rushing in the front of the own vehicle lane is firstly performed and the detecting of the interrupting vehicle is secondly is performed since there is a high possibility that the own vehicle hit the abruptly rushing-in person, comparing with supposition 11.

Again in FIG. 10, the supposition situation selecting section 143 selects supposition situation 13 as a supposition situation closest to the present situation of the own vehicle on the basis of the supposition situation selection table E when it determines that the own vehicle is traveling in the place where a person cannot travel. Supposition situation 13 is a situation in which there is much traffic and there is a low possibility that a pedestrian or a bicycle is present. Accordingly, supposition situation 13 is the situation in which a driver has to be most careful of the interrupting vehicle since there is a possibility that the own vehicle collides with the abruptly interrupting vehicle, but there is a low possibility that the own vehicle hits the abruptly rushing-in person. The supposition situation selecting section 143 supplies the detection process selecting portion 151 with information indicating that the supposition situation selecting section has selected supposition situation 13.

The detection process selecting portion 151 selects the detection process D2 as the detection process to be performed in supposition situation 13 on the basis of the detection process selection table 172 shown in FIG. 4. Afterward, the above-described detection process D2 and an operation corresponding to the detection result of the detection process D2 are performed.

In this way, in supposition situation 13, only the detecting of the interrupting vehicle is first performed since there is a low possibility that a person abruptly rushes, and operations of the own vehicle are controlled in accordance with the detection result.

Again in FIG. 10, the supposition situation selecting section 143 selects supposition situation 14 as a supposition situation closest to the present situation of the own vehicle on the basis of the supposition situation selection table E when it determines that an object is present in the front outside of the own vehicle lane and the own vehicle is traveling in the place where a person can travel and there is a little traffic. Supposition situation 14 is a situation in which an object such as a vehicle or a person is present in the front outside of the own vehicle lane and away from the own vehicle in the place where there is a little traffic. Accordingly, supposition situation 14 is the situation in which a driver has to be careful of the road surface state since there is a low possibility that the own vehicle collides an interrupting vehicle or hits an abruptly rushing-in person, but there is a possibility that another vehicle can be damaged or another person can be injured due to a pebble splattering from a gravel road or the like. The supposition situation selecting section 143 supplies the detection process selecting portion 151 with information indicating that the supposition situation selecting section has selected supposition situation 14.

The detection process selecting portion 151 selects a detection process A2 as a detection process to be performed in supposition situation 14 on the basis of the detection process selection table 172 shown in FIG. 4. The detection process selecting portion 151 turns the switch 152-1 on and supplies the road surface status detecting portion 161 with information indicating a command for performing the detection process A2 through the switch 152-1.

The road surface status detecting portion 161 performs the detection process A2. Specifically, the road surface status detecting portion 161 acquires the forward side image photographed by the visible light camera 131F from the data pre-processing circuit 142. Using a predetermined technique, the road surface status detecting portion 161 performs detecting of an area in which the forward side image of the road surface in the front of the own vehicle is photographed, in order to detect whether the road is a gravel road. Through the output I/F circuit 146, the road surface status detecting portion 161 supplies the vehicle control ECU 102 with information indicating whether the road is the gravel road. In addition, through the switch 152-1, the road surface status detecting portion 161 supplies the detection process selecting portion 151 with information indicating that the detection process A2 has ended. The detection process selecting portion 151 turns the switch 152-1 off.

When the road is the gravel road, the vehicle control ECU 102 controls each element of the own vehicle so as to perform operations in accordance therewith, for example, an operation of making a display or a warning for prompting a driver to be careful or the like.

In this way, in supposition situation 14, the detecting whether the road is the gravel road is first performed since there is a low possibility that the own vehicle collides with the object such as a vehicle or a person, but there is a possibility that another vehicle is damaged or another person is injured due to a pebble splattering from a gravel road or the like in a case where the own vehicle is traveling in the gravel road. Afterward, an operation of the own vehicle is controlled in accordance with the detection result.

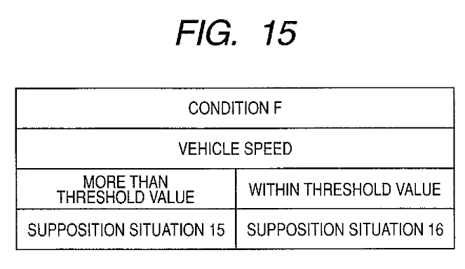

Again in FIG. 10, next, the supposition situation selecting section 143 refers to a supposition situation selection table F shown in FIG. 15 on the basis of the supposition situation selection table F when it determines that an object is not present in the front outside of the own vehicle lane and that the own vehicle is traveling in the place where a person can travel and there is a little traffic. The supposition situation selecting section 143 selects a supposition situation closest to the present situation of the own vehicle on the basis of a condition F shown in a title of the supposition situation selection table F.

The condition F is a condition based on the vehicle speed of the own vehicle, and it is determined whether the vehicle speed of the own vehicle exceeds a threshold value. The supposition situation selecting section 143 determines whether the vehicle speed of the own vehicle detected by the vehicle speed sensor 121 exceeds a predetermined threshold value (for example, 60 km/h).

The supposition situation selecting section 143 selects supposition situation 15 as a supposition situation closest to the present situation of the own vehicle on the basis of the supposition situation selection table F when the vehicle speed of the own vehicle exceeds the threshold value. Supposition situation 15 is a situation in which there is a possibility that the vehicle speed of the own vehicle exceeds a speed limit and the own vehicle is traveling at a violation speed. Accordingly, supposition situation 15 is the situation in which a driver has to be careful of the speed limit of the traveling road. The supposition situation selecting section 143 supplies the detection process selecting portion 151 with information indicating that the supposition situation selecting section has selected supposition situation 15.

The supposition situation selecting section 151 selects a detection process G as a detection process to be performed in supposition situation 15 on the basis of the detection process selection table 172 shown in FIG. 4. The detection process selecting portion 151 turns the switch 152-7 on and supplies the speed limit detecting portion 167 with information indicating a command for performing the detection process G through the switch 152-7.

The speed limit detecting portion 167 performs the detection process G. Specifically, the speed limit detecting portion 167 acquires the forward side image photographed by the visible light camera 131F from the data pre-processing circuit 142. On the basis of the forward side image, the speed limit detecting portion 167 detects the speed limit presented on a road surface or on a road sign in the front of the own vehicle lane, using a predetermined technique. The speed limit detecting portion 167 supplies the vehicle control ECU 102 with information indicating the detected speed limit through the output I/F circuit 146. In addition, through the switch 152-7, the speed limit detecting portion 167 supplies the detection process selecting portion 151 with information indicating that the detection process G has ended. The detection process selecting portion 151 turns the switch 152-7 off.

When the own vehicle is traveling at a speed exceeding the detected speed limit, the vehicle control ECU 102 controls each element of the own vehicle so as to perform operations in accordance therewith, for example, an operation of making a display or a warning for prompting a driver to be careful, or the like.

In this way, in supposition situation 15, the detecting of the speed limit of the traveling road is first performed since there is a possibility that the vehicle speed of the own vehicle exceeds the speed limit and the own vehicle is traveling at the violation speed. Afterward, an operation of the own vehicle is controlled in accordance with the detection result.

Again in FIG. 15, the supposition situation selecting section 143 selects supposition situation 16 as a supposition situation closest to the present situation of the own vehicle on the basis of the supposition situation selection table F when it determines that the vehicle speed of the own vehicle does not exceed the threshold value. Supposition situation 16 is a situation in which the own vehicle is traveling with safety, there is a low possibility that the own vehicle collides with the surrounding object such as a vehicle or a person, there is a low possibility that the oven vehicle damages another vehicle or injures another person, and the own vehicle is traveling at an appropriate speed of a road. The supposition situation selecting section 143 supplies the detection process selecting portion 151 with information indicating that the supposition situation selecting section has selected supposition situation 16.

On the basis of the detection process selection table 172 shown in FIG. 4, the detection process selecting portion 151 recognizes that there is no detection process to be performed in supposition situation 16. That is, the detection process is not performed.

Again in FIG. 2, in Step S6, the detecting system 101 determines that a power source has stopped. When it is determined that the power source does not stop, the process is returned to Step S3. In Step S6, the processes of Step S3 to S6 are reiterated until it is determined that the power source has stopped.

In Step S6, the detecting system 101 determines that the power source has stopped when an engine of the own vehicle stops and the power source to the detecting system 101 stops, for example, and terminates the detection process.

It is possible to detect information required to control the own vehicle effectively and appropriately in accordance with the present situation of the own vehicle. As a result, it is possible to suppress a capability of hardware required to perform the detection processes. Moreover, it is possible to prevent the increase in the size of the hardware of the detecting device.

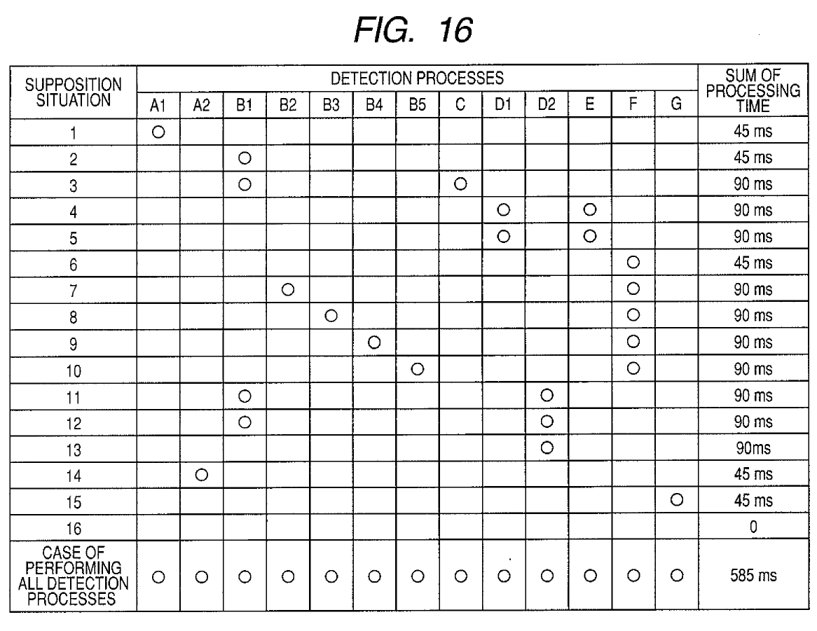

FIG. 16 shows an example of types of the detection processes selected in supposition situations 1 to 16, a sum of processing time required to perform the selected detection processes, and a sum of processing time in a case of performing all the detection processes. In FIG. 16, the processing time required to perform the detection processes A1 to G is assumed to be 45 milliseconds in order to simplify description.

As shown in the lowest row of FIG. 16, the sum of the processing time is 585 milliseconds in the case of performing all the detection processes. For example, the detection device 113 is required to notify a detection result to the vehicle control ECU 102 every 100 milliseconds when the vehicle control ECU 102 performs the detection process in a cycle of 100 milliseconds. Accordingly, in order to perform every detection process every time, for example, it is necessary to increase hardware such as the CPU and the CPU core for performing the detection process.

However, it is possible to control the sum of the processing time up to 90 milliseconds by performing the detection processes to be performed in accordance with the present situation of the own vehicle. Accordingly, it is not necessary to increase the hardware since the detection processes can be terminated within 100 milliseconds, which is the time limit. Moreover, it is possible to suppress deterioration of safety or convenience of the own vehicle, the deterioration being generated because all the detection processes are not performed, since the information to be detected is appropriately selected in accordance with the present situation of the own vehicle. Moreover, it is possible to suppress generation of thermo-runaway occurring due to heat generation or reduction in life span since a use ratio of the hardware such as the CPU decreases.

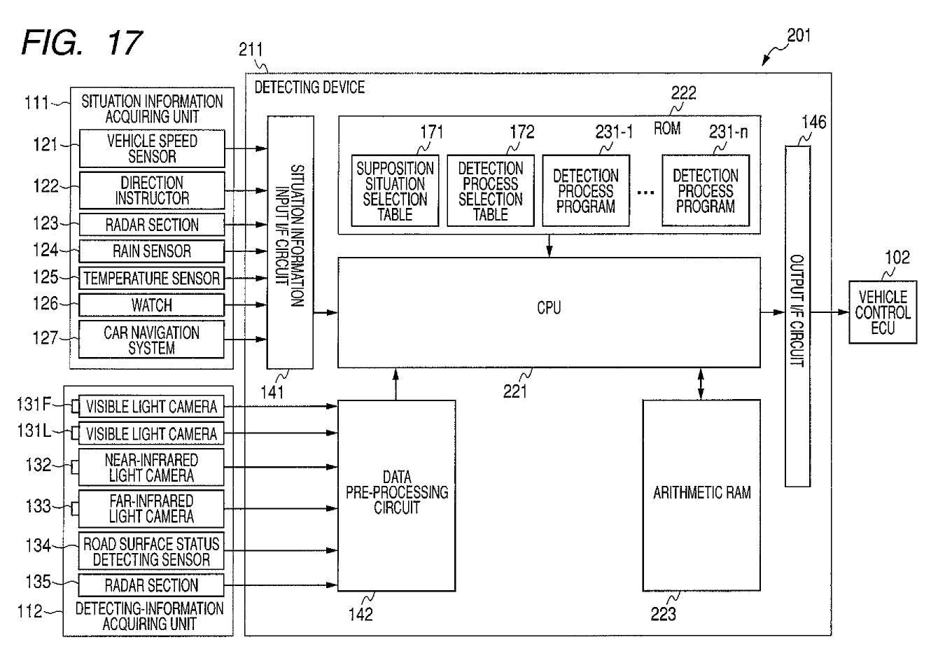

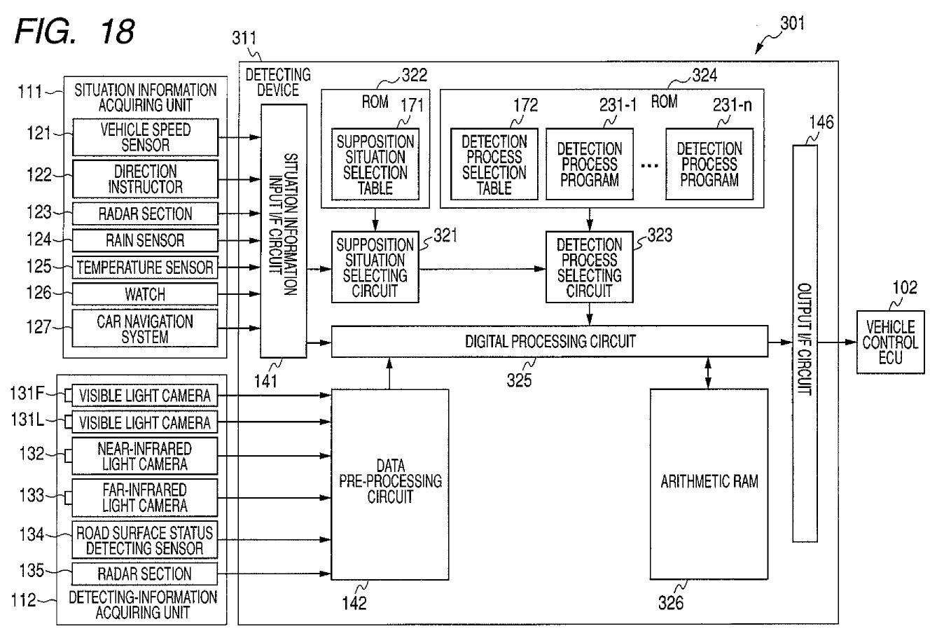

Next, an example of a specific circuit configuration for realizing the detecting device 113 of FIG. 1 will be described with reference to FIGS. 17 and 18.

A detecting system 201 shown in FIG. 17 is configured so as to include a situation information acquiring unit 111, a detecting-information acquiring unit 112, and a detecting device 211. In addition, the detecting device 211 is configured so as to include a situation information input I/F circuit 141, a data pre-processing circuit 142, an output I/F circuit 146, a CPU (Central Processing Unit) 221, an ROM (Read-only Memory) 222, and an arithmetic RAM (Random Access Memory) 223. In the drawing, the same reference numerals are given to the elements corresponding to the elements of FIG. 1 and the description will be omitted without repetition.

In the detecting device 211, the CUP 221 executes the processes of the supposition situation selecting portion 143, the detection process controller 144, and the target detecting section 145 of the detecting device 113 shown in FIG. 1. Specifically, the CPU 221 acquires data indicating situation information detected by the vehicle speed sensor 121, the detecting instructor 122, the radar section 123, the rain sensor 124, the temperature sensor 125, the clock 126, and the car navigation system 127 from the situation information input I/F circuit 141. Like the supposition situation selecting section 143 shown in FIG. 1, the CPU 221 selects a supposition situation closest to the present situation of the own vehicle on the basis of the acquired situation information and the supposition situation selection table 171 stored in the ROM 222. The CPU 221 selects the detection processes to be actually performed on the basis of the selected supposition situation and the detection process selection table 172 stored in the ROM 222, and determines a sequence for performing the selected detection processes.

Detection process programs 231-1 to 231-n for performing each detection process are stored in the ROM 222. The detection process programs 231-1 to 231-n may each be configured as a different program for each detection process, and may be configured as the same program for executing the detection process for the same target. For example, the same detection process program can be configured to be used for the detection processes B1 to B6 by varying a parameter when the program is executed so that the detection process to be performed is converted.

The CPU 221 loads the detection process program corresponding to the next detection process to be performed from the ROM 222 in accordance with the sequence for performing the selected detection processes, and execute the loaded detection process program. The CPU 221 acquires an image photographed by a visible light camera 131F, a visible light camera 131L, a near-infrared light camera 132, or a far-infrared light camera 133, or data indicating a detection result of a road surface status monitoring sensor 134 or a radar section 135 from the data pre-processing circuit 142. In addition, the CPU executes the detection process corresponding to the loaded detection process program on the basis of the situation information, or the image or the data acquired from the data pre-processing circuit 142. The CPU 221 supplies a vehicle control ECU 102 with information indicating the detection result acquired by performing the detection process through the output I/F circuit 146. The arithmetic RAM 223 stores a parameter, data, or the like which varies in executing of the processes of the CPU 221.

A detecting system 301 shown in FIG. 18 is configured so as to include a situation information acquiring unit 111, a detecting-information acquiring unit 112, and a detecting device 311. In addition, the detecting device 311 is configured so as to include a situation information input I/F circuit 141, a data pre-processing circuit 142, an output I/F circuit 146, a supposition situation selecting circuit 321, an ROM 322, a detection process selecting circuit 323, an ROM 324, a digital processing circuit 325, and an arithmetic RAM 326. In the drawing, the same reference numerals are given to elements corresponding to the elements shown in FIG. 1 or 17, and the description will be omitted without repetition.

In the detecting device 311, the processes performed in the supposition situation selecting section 143 of the detecting device 113 shown in FIG. 1 are performed by the supposition situation selecting circuit 321. The processes performed by the detection process controller 144 are performed by the detection process selecting circuit 323. The processes performed by the target detecting section 145 are performed by the digital processing circuit 325.

Specifically, the supposition situation selecting circuit 321 acquires data indicating situation information detected by a vehicle sensor 121, a direction instructor 122, a radar section 123, a rain sensor 124, a temperature sensor 125, a clock 126, and a car navigation system 127 from the situation information input I/F circuit 141. Like the supposition situation selecting section 143 shown in FIG. 1, the supposition situation selecting circuit 321 selects a supposition situation closest to the present situation of the own vehicle on the basis of the acquired situation information and a supposition situation selection table 171 stored in the ROM 322. The supposition situation selecting circuit 321 supplies the detection process selecting circuit 323 with information indicating the selected supposition situation The detection process selecting circuit 323 selects the detection processes to be performed, on the basis of the selected supposition situation and a detection process selection table 172 stored in the ROM 324, and determines a sequence for performing the selected detection processes.

In the ROM 324, detection process programs 331-1 to 331-n for executing each detection process are stored in addition to the detection process selection table 172. The detection process programs 331-1 to 331-n may each be configured as a different program for each detection process, and may be configured as the same program for executing the detection process for the same target. For example, the same detection process program can be configured to be used for the detection processes B1 to B6 by varying a parameter when the program is executed so that the detection process to be performed is converted.

The detection process selecting circuit 323 converts the state of a hardware switch therein in accordance with a sequence for performing the determined detection process to read the detection process program corresponding to the next detection process to be performed from the ROM 324 and to supply it to the digital processing circuit 325.

The digital processing circuit 325 is configured by circuits or processors which can re-configure inner circuits during operation, for example, an SRAM (Static Random Access Memory) type FPGA (Field Programmable Gate Array), a DRP (Dynamically Reconfigurable Processor), and the like. The digital processing circuit 325 re-configures the inner circuits so as to perform the corresponding detection process on the basis of the detection process program supplied from the detection process selecting circuit 323. The digital processing circuit 325 acquires the image photographed by the visible light camera 131F, the visible light camera 131L, the near-infrared light camera 132, or the far-infrared light camera 133 or the data indicating the detection result of the road surface status monitoring sensor 134 or the radar section 135 from the data pre-processing circuit 142. In addition, the digital processing circuit performs the detection process selected by the detection process selecting circuit 323 on the basis of the situation information, or the image or the data acquired from the data pre-processing circuit 142. The digital processing circuit 325 supplies the vehicle control ECU 102 with the information indicating the detection result obtained by performing the detection process through the output I/F circuit 146. The arithmetic RAM 326 stores an appropriately varying parameter, data, or the like in performing the process of the digital processing circuit 325.

In the foregoing description, the example in which the supposition situations are uniquely selected, but the supposition situations may be selected using a probable parameter. Accordingly, when it is difficult to uniquely select the supposition situations, a supposition situation closest to the present situation can be selected without bias of a specific supposition situation. Therefore, necessary information of a target can be detected for a shorter period of time. For example, in a situation in which it is difficult to uniquely select the appropriate distance between vehicles, a specific supposition situation is prevented from being only selected by having a value of the appropriate distance between vehicles and by varying the value at a predetermined probability in the condition C2 of the supposition situation selection table C shown in FIG. 6. The above-described probable parameter may be optimized by a leaning process.

In the foregoing description, the example in which the types and sequence of the detection processes to be performed are determined in accordance with the selected supposition situation. However, for example, a priority order is set for all the detection processes and the detection processes from the detection process with the highest priority may be performed in accordance with the priority order within a permissible process period of time. Accordingly, for example, in a case in which a CPU, a digital processing circuit, or the like for performing the detection processes has a sufficient processing capacity, the more detection processes can be performed. Alternatively, in a case in which the CPU, the digital processing circuit, or the like has a insufficient processing capacity, only necessary detection processes can be performed.

Instead of the rain sensor 124, weather may be determined on the basis of a signal output from a switch of a wiper of the own vehicle.

Instead of the supposition situation selection table 171, a flowchart or the like for selecting the supposition situations may be used on the basis of each condition.

When the supposition situation 14 is selected, detecting of a puddle of a road may be performed to prevent water from splashing to another vehicle or another person.

The situation information is not limited to the above-described examples. For example, information on the location or rotation direction a steering wheel of the own vehicle, traffic congestion information, information on a road shape, or the like may be used.

The invention is applicable to, for example, an in-vehicle image processing device which detects information on a plurality of predetermined targets by performing an image process.

The above-described series of processes can be performed by hardware and may be performed by software. When the series of processes are performed by software, a program of the software is installed from a program recording medium to a computer mounted in hardware for exclusive use or a general personal computer capable of executing various functions by installing various programs, for example.

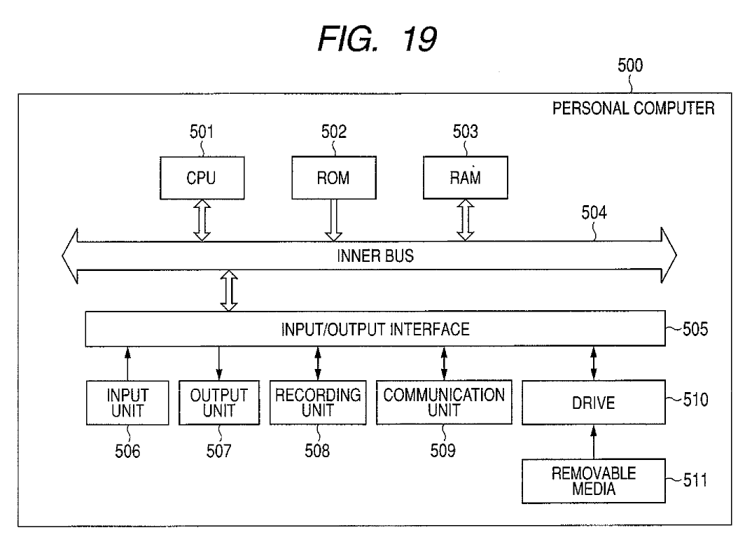

FIG. 19 is a block diagram illustrating an example of a configuration of a person computer 500 which executes the above-described series of processes by a program. A CPU (Central Processing Unit) 501 executes various processes in accordance with a program stored in an ROM (Read-only Memory) 502 or a recording unit 508. Programs or data executed by the CPU 501 are appropriately stored in an RAM (Random Access Memory) 503. The CPU 501, the ROM 502, and the RAM 503 are connected to each other through a bus 504.

An input/output interface 505 is connected to the CPU 501 through the bus 504. An input unit 506 composed of a keyboard, a mouse, a microphone, and the like and an output unit 507 composed of a display, a speaker, and the like are connected to the input/output interface 505. The CPU 501 executes various processes corresponding to commands input from the input unit 506. In addition, the CPU 501 outputs the process results to the output unit 507.

A recording unit 508 connected to the input/output interface 505 is configured as, for example, a hard disk and stores the program executed by the CPU 501 or various types of data. A communication unit 509 communicates with an external device through a network such as the Internet or a local area network.

Moreover, a program may be acquired through the communication unit 509 and may be stored in the recording unit 508.

A drive 510 connected to the input/output interface 505 acquires the program or data stored in a removable media 511 by driving the removable media when the removable media such as a magnetic disk, an optical disk, a magnetic optical disk, a semiconductor memory, or the like is mounted. The acquired program or data is transported to the recording unit 508 and stored, if necessary.

A program recording medium for storing a program installed on a computer and prepared to be executed by the computer is configured by the removable media 511 such as a magnetic disk (including a flexible disk), an optical disk (including CD-ROM (Compact Disk Read-only Memory) and a DVD (Digital Versatile Disk)), a magnetic optical disk, a semiconductor memory, or the like; the ROM 502 for temporarily or permanently storing a program; or a hard disk configuring the recording unit 508, as shown in FIG. 19. Storing of a program to the program recording medium is performed through the communication unit 509 such as a modem or a router, if necessary, using a wired or wireless communication medium such as a local area network, the Internet, and digital satellite broadcasting.

In this specification, a step of describing a program stored in the program recording medium may be performed in a time-oriented manner in accordance with a described sequence. However, the step may not be necessarily performed in the time-oriented manner, but may be performed in a parallel or individual manner.

In this specification, a system refers to an entire device configured by a plurality of elements.

Moreover, the invention is not limited to the above-described embodiment, but may be modified in various forms in a range without departing the gist of the invention.

What is claimed is:

1. A detecting device which performs a plurality of detection processes of detecting information on a predetermined target, the information being used to control a vehicle, and detects information on a plurality of the targets, the detecting device comprising:
situation selecting means for selecting a supposition situation closest to a situation of the vehicle from a plurality of the supposition situations supposed in advance on the basis of information on a state of the vehicle or a surrounding situation of the vehicle; and
detection process selecting means for selecting the detection process to be actually performed from the plurality of detection processes on the basis of the selected supposition situation.

2. The detecting device according to claim 1, wherein the detection process selecting means determines a sequence for performing the detection processes on the basis of the supposition situation.

3. The detecting device according to claim 1, wherein the supposition situation is a situation which is supposed on the basis of a situation in which a driver has to be careful during driving.

4. The detecting device according to claim 1, wherein the detection process selecting means selects the detection process of detecting information on the target which a driver has to be careful of in the selected supposition situation.

5. The detecting device according to claim 4, wherein the detection process selecting means determines a sequence for performing the detection processes on the basis of a sequence of the targets which a driver has to be careful of.

6. A method of controlling a detection process of a detecting device which performs a plurality of the detection processes of detecting information on a predetermined target, the information being used to control a vehicle, and detects information on a plurality of the targets, the method comprising:
a situation selecting step of selecting a supposition situation closest to a situation of the vehicle from a plurality of the supposition situations supposed in advance on the basis of information on a state of the vehicle or a surrounding situation of the vehicle; and
a detection process selecting step of selecting the detection process to be performed from the plurality of detection processes on the basis of the selected supposition situation.

7. A program for allowing a detection process controlling process to be executed on a computer of a detecting device which performs a plurality of detection processes of detecting information on a predetermined target, the information being used to control a vehicle, and detects information on a plurality of the targets, the program comprising:
a situation selecting step of selecting a supposition situation closest to a situation of the vehicle from a plurality of the supposition situations supposed in advance on the basis of information on a state of the vehicle or a surrounding situation of the vehicle; and
a detection process selecting step of selecting the detection process to be performed from the plurality of detection processes on the basis of the selected supposition situation.
